(19) United States
(12) Patent Application Publication
(10) Pub. No.: US 2026/0291597 A1
(43) Pub. Date: Sep. 24, 2026

(54) JOINT INDICATION OF QCL PDP AND CROSS SLOT CHANNEL ESTIMATION

(71) Applicant: QUALCOMM Incorporated, San Diego, CA (US)

(72) Inventors: Somsubhra BARIK, San Diego, CA (US); Jing SUN, San Diego, CA (US); Chih-Hao LIU, San Diego, CA (US)

(21) Appl. No.: 19/088,666

(22) Filed: Mar. 24, 2025

(51) Int. Cl. H04B 7/06; H04L 25/02; H04L 27/26; H04W 72/23

(52) U.S. Cl. CPC H04B 7/06968; H04L 25/0202; H04L 27/261; H04W 72/23

(57) ABSTRACT

The apparatus may be a UE configured to receive, in association with at least a first slot and a second, adjacent slot, a first indication to perform a joint channel estimation for at least one of the first slot or the second slot based on first DMRS associated with the first slot and second DMRS associated with the second slot, receive, for the first slot, a second indication of a type of QCL of the first DMRS with a reference DMRS associated with a reference slot, where the type of QCL indicates to perform an update to information based on the reference set of DMRS used for the joint channel estimation, where the second indication is based on the first indication, and perform, based on the first indication and the information, the joint channel estimation for at least one of the first slot or the second slot.

### TECHNICAL FIELD

The present disclosure relates generally to communication systems, and more particularly, to wireless communication that includes channel estimation.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard, and some aspects of future wireless communication technologies may be based on aspects of 5G NR. There exists a need for further improvements in 5G NR technology, such as 6G, among other examples. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a wireless device such as a user equipment (UE) configured to receive, in association with at least a first slot and a second slot adjacent to the first slot, a first indication to perform a joint channel estimation for at least one of the first slot or the second slot based on at least a first set of demodulation reference signals (DMRSs) associated with the first slot and a second set of DMRSs associated with the second slot, receive, for the first slot, a second indication of a type of quasi-co-location (QCL) of the first set of DMRSs with a first reference set of DMRSs associated with a first reference slot, where the type of QCL indicates to the UE to perform an update to information used for the joint channel estimation, where the information is based on the first reference set of DMRSs, where the second indication of the type of QCL of the first set of DMRSs is based on the first indication to perform the joint channel estimation, perform, based on the first indication and the information, the joint channel estimation for the at least one of the first slot or the second slot, and output a response associated with the joint channel estimation for the at least one of the first slot or the second slot.

In an aspect of the disclosure, a method, a computer-readable medium, and an apparatus are provided. The apparatus may be a network device such as a base station configured to transmit, in association with at least a first slot and a second slot adjacent to the first slot, a first indication for a UE to perform a joint channel estimation for at least one of the first slot or the second slot based on at least a first set of DMRSs associated with the first slot and a second set of DMRSs associated with the second slot, and transmit, for the first slot, a second indication of a type of QCL of the first set of DMRSs with a first reference set of DMRSs associated with a first reference slot, where the type of QCL indicates to the UE to perform an update to information used for the joint channel estimation, where the information is based on the first reference set of DMRSs, where the second indication of the type of QCL of the first set of DMRSs is based on the first indication to perform the joint channel estimation for at least one of the first slot or the second slot.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4A is a diagram illustrating a causal DMRS combining for a joint channel estimation.

FIG. 4B is a diagram illustrating a causal DMRS combining for a joint channel estimation.

FIG. 5 is a diagram illustrating aspects associated with an indication of a type of QCL of a first DMRS of a first port with a second DMRS of a second port in accordance with some aspects of the disclosure.

FIG. 6 is a diagram illustrating some aspects of an indication of a type of QCL between a first DMRS and a second DMRS in accordance with some aspects of the disclosure.

FIG. 7A is a diagram illustrating a non-limiting example of a use of a special index for a type of QCL indication associated with a causal DMRS combining for a joint channel estimation in accordance with some aspects of the disclosure.

FIG. 7B is a diagram illustrating a non-limiting example of a use of a special index for a type of QCL indication associated with a non-causal DMRS combining for a joint channel estimation in accordance with some aspects of the disclosure.

FIG. 8A is a diagram illustrating a non-limiting example of a use of a special index for a type of QCL indication associated with a causal DMRS combining for a joint channel estimation in accordance with some aspects of the disclosure.

FIG. 8B is a diagram illustrating a non-limiting example of a use of a special index for a type of QCL indication associated with a non-causal DMRS combining for a joint channel estimation in accordance with some aspects of the disclosure.

FIG. 9 is a diagram illustrating a non-limiting example of a use of a special index for a type of QCL indication associated with a non-causal DMRS combining for a joint channel estimation across a plurality of slots in accordance with some aspects of the disclosure.

FIG. 10 is a call flow diagram illustrating a method of wireless communication in accordance with some aspects of the disclosure.

FIG. 11 is a flowchart of a method of wireless communication.

FIG. 12 is a flowchart of a method of wireless communication.

FIG. 13 is a flowchart of a method of wireless communication.

FIG. 14 is a flowchart of a method of wireless communication.

FIG. 15 is a diagram illustrating an example of a hardware implementation for an example apparatus and/or network entity.

FIG. 16 is a diagram illustrating an example of a hardware implementation for an example network entity.

### DETAILED DESCRIPTION

In some aspects of wireless communication, a receiver may decode a received signal based on a channel estimation performed at the receiver (e.g., a receiving device such as a UE or other wireless device). The channel estimation, in some aspects, may be based on one or more reference signals, e.g., a tracking reference signal (TRS) or a DMRS, among other example reference signals. In some aspects, to estimate a channel (e.g., to generate a channel estimation) a UE may determine, or calculate, a power delay profile (PDP) or frequency domain (FD) correlation associated with the channel. The PDP or FD correlation may be based on the one or more reference signals used for the channel estimation, e.g., the TRS or the DMRS. In some aspects, the PDP or FD correlation may be applied to, or used as an input for, a minimum mean squared error (MMSE) based channel estimation. For example, in some aspects, the MMSE matrix may be quantized as a function of a delay spread of the PDP, where the receiver may estimate the delay spread of PDP and select and/or determine the MMSE matrix accordingly.

A delay spread or PDP, in some aspects, may be associated with a signal that travels over a plurality of different paths that make up a channel associated with communication between a transmitter of the signal and a receiver of the signal. The signal traveling over the different paths may arrive at the receiver at a corresponding plurality of different times and with a corresponding plurality of powers that may be used to calculate one or more measures of the delay spread of the channel. Measures of delay spread such as a max delay spread, an average delay spread, or a root mean square (RMS) delay spread, in some aspects, may describe different aspects of the channel (e.g., the delay spread or PDP associated with the channel). In some aspects, a receiver may compute, or calculate, an FD correlation and/or an average PDP of the received channel Ĥ(k) using the following equation:

$${R}_{\hat{H} \hat{H} , l} [ k ] = {\sum }_{r} {\sum }_{PRG} 1 / N ( k ) {\sum }_{m} {\hat{H}}_{r , l} ( k + m ) {\hat{H}}_{r , l} * ( m )$$

In this example, Ĥ_{r,l}(m) denotes the received channel at tone index ‘m’ (an m^{th} subcarrier), antenna ‘r’, and associated with an ‘l^{th}’ layer, and N(k) denotes the number of tones (or subcarriers) available for averaging for a tone offset of k.

In some aspects, a type of quasi-co-location (QCL) relationship (which may be referred to as a QCL Type E or Type E QCL) may indicate that the average FD correlation and/or the average PDP (e.g., averaged over the precoding resource groups (PRGs) of the channel), or an average delay and average delay spread, are equivalent for the quasi co-located (QCL'ed) ports (e.g., DMRS ports). For example, the type of QCL may indicate that a subset of characteristics and/or parameters associated with an antenna port are correlated with (e.g., which may be referred to as shared with, inherited by, etc.) the same subset of characteristics and/or parameters associated with the QCL'ed ports. In some aspects, the subset of characteristics or parameters indicated by QCL relationship may be used e.g., for a channel estimation.

In some aspects, a joint channel estimation across slots (sometimes referred to as cross-slot channel estimation) may be performed when a same precoding is used for the DMRS and data associated with the plurality of slots for which the joint channel estimation is performed. The joint channel estimation may be identified, or classified, as one of causal or non-causal. A causal joint channel estimation, in some aspects, may be associated with a channel estimation for a subsequent slot (e.g., a slot n+1) based on a DMRS of a previous slot (e.g., a slot n). In some aspects, a non-causal joint channel estimation may be associated with a channel estimation for a previous slot (e.g., the slot n) based on a DMRS of a subsequent slot (e.g., the slot n+1). To trigger the joint channel estimation, a control signal may be exchanged between a transmitting and receiving device. As the same precoding is expected to be associated with a same average delay and average delay spread (or with a same PDP and/or FD correlation), the condition for performing the joint channel estimation for a plurality of slots may be sufficient for the plurality of slots (or ports of the plurality of slots) to have the type of QCL indicating an average delay and average delay spread are equivalent across the slots and/or ports.

Various aspects relate generally to a method for joint indication of QCL PDP and cross-slot channel estimation. Some aspects more specifically relate to, utilizing causal and non-causal DMRS combining across transmission time intervals (TTIs) with special index classes (e.g., special codepoints or codepoint indices) for a type of QCL signaling (e.g., QCL Type E signaling), allowing for dynamic indication by the base station of QCL information and filtering coefficients. In some examples, a UE may be configured to receive, in association with at least a first slot and a second slot adjacent to the first slot, a first indication to perform a joint channel estimation for at least one of the first slot or the second slot based on at least a first set of DMRSs associated with the first slot and a second set of DMRSs associated with the second slot, receive, for the first slot, a second indication of a type of QCL of the first set of DMRSs with a first reference set of DMRSs associated with a first reference slot, where the type of QCL indicates to the UE to perform an update to information used for the joint channel estimation, where the information is based on the first reference set of DMRSs, where the second indication of the type of QCL of the first set of DMRSs is based on the first indication to perform the joint channel estimation, perform, based on the first indication and the information, the joint channel estimation for the at least one of the first slot or the second slot, and output a response associated with the joint channel estimation for the at least one of the first slot or the second slot. In some examples, a network device such as a base station may be configured to transmit, in association with at least a first slot and a second slot adjacent to the first slot, a first indication for a UE to perform a joint channel estimation for at least one of the first slot or the second slot based on at least a first set of DMRSs associated with the first slot and a second set of DMRSs associated with the second slot, and transmit, for the first slot, a second indication of a type of QCL of the first set of DMRSs with a first reference set of DMRSs associated with a first reference slot, where the type of QCL indicates to the UE to perform an update to information used for the joint channel estimation, where the information is based on the first reference set of DMRSs, where the second indication of the type of QCL of the first set of DMRSs is based on the first indication to perform the joint channel estimation for at least one of the first slot or the second slot.

Particular aspects of the subject matter described in this disclosure can be implemented to realize one or more of the following potential advantages. In some examples, by using a joint indication of QCL PDP and cross-slot channel estimation, the described techniques can be used to reduce signaling overhead associated with separate indications of the QCL PDP and cross-slot channel estimation.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems 6G systems, or other communication systems, may be arranged in multiple manners with various components or constituent parts. As an example, in a wireless communication network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

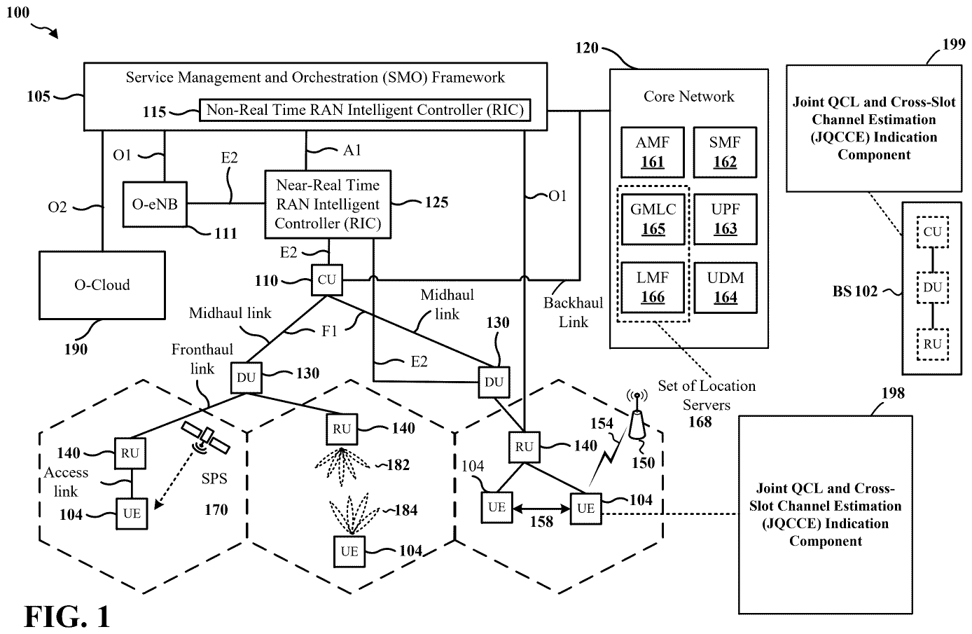

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a joint QCL and cross-slot channel (JQCCE) indication component 198 that may be configured to receive, in association with at least a first slot and a second slot adjacent to the first slot, a first indication to perform a joint channel estimation for at least one of the first slot or the second slot based on at least a first set of DMRSs associated with the first slot and a second set of DMRSs associated with the second slot, receive, for the first slot, a second indication of a type of QCL of the first set of DMRSs with a first reference set of DMRSs associated with a first reference slot, where the type of QCL indicates to the UE to perform an update to information used for the joint channel estimation, where the information is based on the first reference set of DMRSs, where the second indication of the type of QCL of the first set of DMRSs is based on the first indication to perform the joint channel estimation, perform, based on the first indication and the information, the joint channel estimation for the at least one of the first slot or the second slot, and output a response associated with the joint channel estimation for the at least one of the first slot or the second slot. In certain aspects, the base station 102 may have a JQCCE indication component 199 that may be configured to transmit, in association with at least a first slot and a second slot adjacent to the first slot, a first indication for a UE to perform a joint channel estimation for at least one of the first slot or the second slot based on at least a first set of DMRSs associated with the first slot and a second set of DMRSs associated with the second slot, and transmit, for the first slot, a second indication of a type of QCL of the first set of DMRSs with a first reference set of DMRSs associated with a first reference slot, where the type of QCL indicates to the UE to perform an update to information used for the joint channel estimation, where the information is based on the first reference set of DMRSs, where the second indication of the type of QCL of the first set of DMRSs is based on the first indication to perform the joint channel estimation for at least one of the first slot or the second slot. Although the following description may be focused on 5G NR, the concepts described herein may be applicable to other similar areas, such as 6G, LTE, LTE-A, CDMA, GSM, and other wireless technologies.

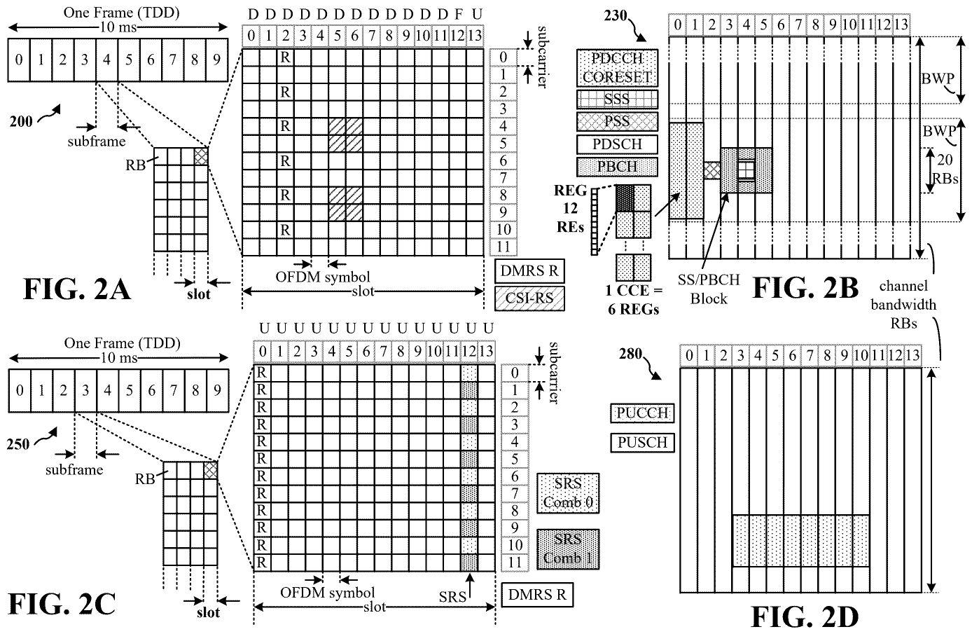

FIG. 2A is a diagram 200 illustrating an example of a first subframe within a 5G NR frame structure. The examples in FIGS. 2A-2D, illustrate aspects of a frame structure based on 5G NR to illustrate the concept of time and frequency resources based on a frame structure. Some aspects may be used in connection with other technology, such as 6G, for example. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

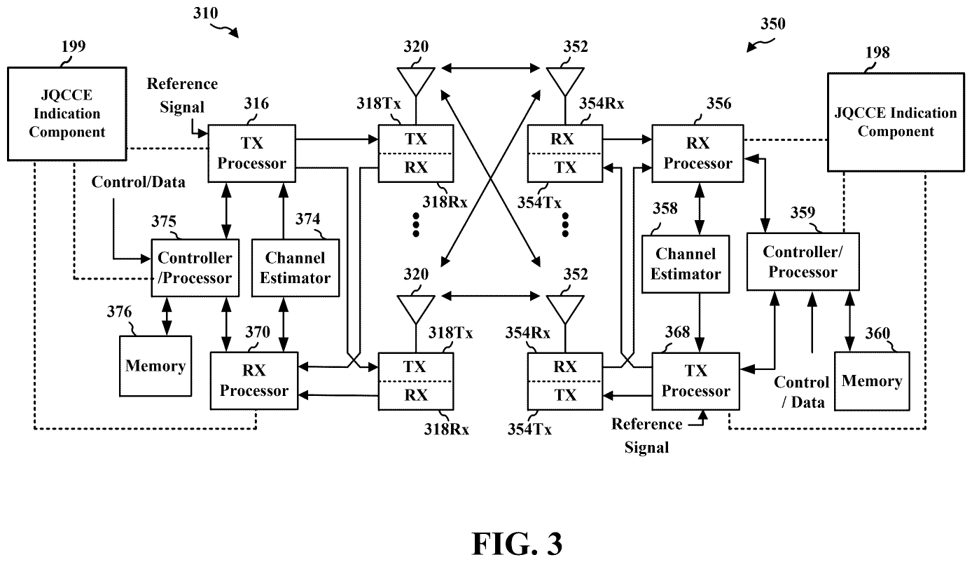

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the JQCCE indication component 198 of FIG. 1.

At least one of the TX processor 316, the RX processor 370, and the controller/processor 375 may be configured to perform aspects in connection with the JQCCE indication component 199 of FIG. 1.

Some aspects of wireless communication may be based on a QCL relationship between signals, e.g., a correlation with respect to large scale channel characteristics between signals from different antenna ports. The correlation may be based on a reference signal, in some aspects. As an example, QCL type A may indicate a correlation with respect to Doppler shift, Doppler spread, average delay, and delay spread. QCL Type B may indicate a correlation with respect to Doppler shift and Doppler spread. QCL Type C may indicate a correlation with respect to average delay and Doppler shift. QCL Type D may indicate a correlation with respect to a spatial parameter (e.g., between directional beams). An indication of a QCL relationship for a first signal may be described as one of an indication of a QCL relationship (or a type of QCL relationship) between the first signal and a reference signal (or antenna port), an indication of a QCL source for the first signal, or an indication of a QCL reference signal (or antenna port) for the first signal. The reference, or source, signal or antenna port may be associated with stored information (e.g., a set of measured, detected, or computed values for the correlated characteristics and/or parameters such as the Doppler shift, Doppler spread, average delay, and delay spread) and the indication of the reference/source signal/antenna port may refer to the use of the stored information in association with, or for, the QCL'ed signal.

In some aspects of wireless communication, a receiver may decode a received signal based on a channel estimation performed at the receiver (e.g., a receiving device such as a UE or other wireless device). The channel estimation, in some aspects, may be based on one or more reference signals, e.g., a TRS or a DMRS, among other example reference signals. In some aspects, to estimate a channel (e.g., to generate a channel estimation) a UE may determine, or calculate, a power delay profile (PDP) or frequency domain (FD) correlation associated with the channel. The PDP or FD correlation may be based on one or more reference signals used for the channel estimation, e.g., the TRS or the DMRS. In some aspects, the PDP or FD correlation may be applied to, or used as an input for, a minimum mean squared error (MMSE) based channel estimation. For example, in some aspects, the MMSE matrix may be quantized as a function of a delay spread of the PDP or the FD correlation, where the receiver may estimate the delay spread of PDP or FD correlation and select and/or determine the MMSE matrix accordingly.

In some aspects, a type of QCL relationship (which may be referred to as a QCL Type E or Type E QCL) may indicate that the average FD correlation and/or the average PDP (e.g., averaged over the precoding resource groups (PRGs) of the channel), or an average delay and average delay spread, are equivalent for the quasi co-located (QCL'ed) ports (e.g., DMRS ports). For example, the type of QCL may indicate that a subset of characteristics and/or parameters associated with an antenna port are correlated with (e.g., which may be referred to as shared with, inherited by, etc.) the same subset of characteristics and/or parameters associated with the QCL'ed ports. In some aspects, the subset of characteristics or parameters indicated by QCL relationship may be used e.g., for a channel estimation. In some aspects, QCL Type E may indicate a correlation for, or associated with, information used to perform a channel estimation (e.g., such as an average delay and delay spread or a PDP and/or FD correlation) and may further indicate for a receiver (e.g., a UE) to update the information based on the signal for which the QCL Type E is indicated. For example, in a QCL Type E indication, a first DMRS may be indicated to have a QCL Type E relationship with a class of reference, or source, signals using a first index into a set of indexed values. Based on the first index included in the QCL Type E indication, the UE may retrieve the (stored) correlated information (e.g., a PDP_{filtered}) based on other DMRSs indicated to have a QCL Type E relationship with the same class of reference/source signals, calculate corresponding information based on the first DMRS (e.g., a PDP_{current}), and update the (stored) correlated information (e.g., the PDP_{filtered}) to be used for a channel estimation for one or more of a first slot associated with the first DMRS or with subsequent slots associated with subsequent DMRSs having a QCL Type E relationship with the same class of reference/source signals. In some aspects, an indication of the QCL Type E relationship may be an index value mapped to the correlated, and stored, information used to perform the channel estimation. The mapping of the index value, in some aspects, may be based on a class index or slot pointer (as described below) associated with the stored information.

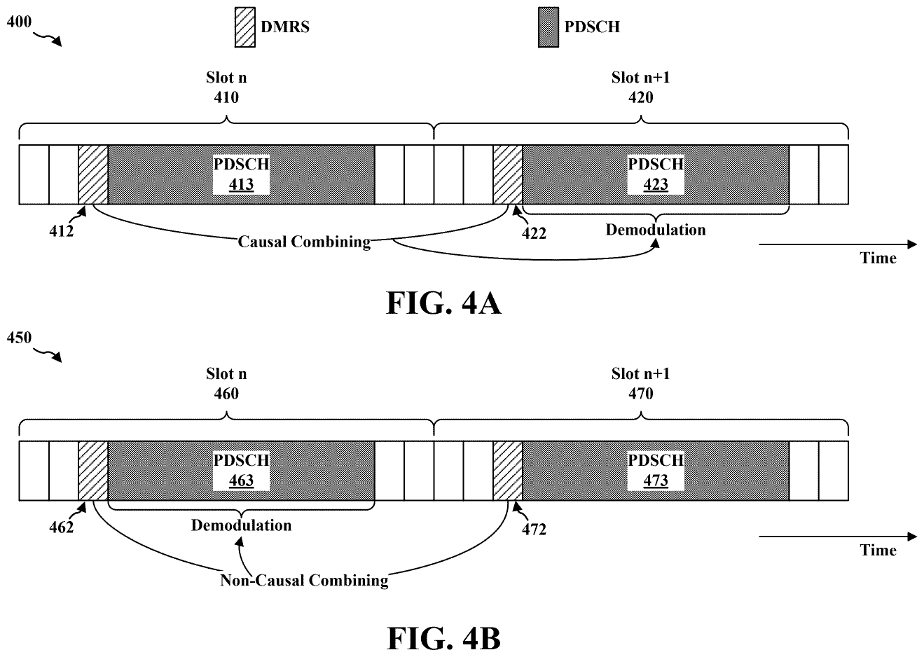

In some aspects, a joint channel estimation across slots (sometimes referred to as cross-slot channel estimation) may be performed when a same precoding is used for the DMRS and data associated with the plurality of slots for which the joint channel estimation is performed. The joint channel estimation may be identified, or classified, as one of causal or non-causal. FIG. 4A is a diagram 400 illustrating a causal DMRS combining for a joint channel estimation. Diagram 400 illustrates a first slot 410 (e.g., “slot n”) including a first DMRS 412 (where a DMRS may include a set of DMRSs) and a PDSCH 413 followed by a second slot 420 (e.g., “slot n+1”) including a second DMRS 422 and a PDSCH 423. Control signaling (not shown) may indicate a causal DMRS combining and/or joint channel estimation (which may be referred to as a cross-slot channel estimation). As illustrated, a causal joint (or cross-slot) channel estimation, in some aspects, may be associated with a channel estimation and demodulation for a subsequent slot (e.g., the second slot 420 or slot n+1) based on a DMRS of a previous slot (e.g., a slot n).

FIG. 4B is a diagram 450 illustrating a causal DMRS combining for a joint channel estimation. Diagram 450 illustrates a first slot 460 (e.g., “slot n”) including a first DMRS 462 (where a DMRS may include a set of DMRSs) and a PDSCH 463 followed by a second slot 470 (e.g., “slot n+1”) including a second DMRS 472 and a PDSCH 473. Control signaling (not shown) may indicate a non-causal DMRS combining and/or joint channel estimation (which may be referred to as a cross-slot channel estimation). As illustrated, in some aspects, a non-causal joint channel estimation may be associated with a channel estimation for a previous slot (e.g., the slot n) based on a DMRS of a subsequent slot (e.g., the slot n+1). To trigger the joint channel estimation, a control signal may be exchanged between a transmitting and receiving device. As the same precoding is expected to be associated with a same average delay and average delay spread (or with a same PDP and/or FD correlation), the condition for performing the joint channel estimation for a plurality of slots may be sufficient for the plurality of slots (or ports of the plurality of slots) to have the type of QCL indicating an average delay and average delay spread are equivalent across the slots and/or ports.

Various aspects relate generally to a method for joint indication of QCL PDP and cross-slot channel estimation. Some aspects more specifically relate to, utilizing causal and non-causal DMRS combining across transmission time intervals (TTIs) with special index classes (e.g., in one or more designated signaling bit) for a type of QCL signaling (e.g., QCL Type E signaling), allowing for dynamic indication by the base station of QCL information and filtering coefficients. In some examples, In some examples, a UE may be configured to receive, in association with at least a first slot and a second slot adjacent to the first slot, a first indication to perform a joint channel estimation for at least one of the first slot or the second slot based on at least a first set of DMRSs associated with the first slot and a second set of DMRSs associated with the second slot, receive, for the first slot, a second indication of a type of QCL of the first set of DMRSs with a first reference set of DMRSs associated with a first reference slot, where the type of QCL indicates to the UE to perform an update to information used for the joint channel estimation, where the information is based on the first reference set of DMRSs, where the second indication of the type of QCL of the first set of DMRSs is based on the first indication to perform the joint channel estimation, perform, based on the first indication and the information, the joint channel estimation for the at least one of the first slot or the second slot, and output a response associated with the joint channel estimation for the at least one of the first slot or the second slot. In some examples, a network device such as a base station may be configured to transmit, in association with at least a first slot and a second slot adjacent to the first slot, a first indication for a UE to perform a joint channel estimation for at least one of the first slot or the second slot based on at least a first set of DMRSs associated with the first slot and a second set of DMRSs associated with the second slot, and transmit, for the first slot, a second indication of a type of QCL of the first set of DMRSs with a first reference set of DMRSs associated with a first reference slot, where the type of QCL indicates to the UE to perform an update to information used for the joint channel estimation, where the information is based on the first reference set of DMRSs, where the second indication of the type of QCL of the first set of DMRSs is based on the first indication to perform the joint channel estimation for at least one of the first slot or the second slot.

The receiver may maintain, or store, information regarding the computed FD correlations or PDPs in multiple slots and can leverage, or use, the maintained, or stored, information for channel estimation for current and/or subsequent slots. For example, in some aspects, the UE may store PDPs associated with multiple slots and filter PDPs across slots (e.g., across slots having equivalent FD correlations or equivalent PDPs and/or a QCL type E relationship) to help improve channel estimation performance of a current slot.

In some aspects, a transmitter (e.g., a base station) may dynamically indicate QCL information (e.g., QCL Type E information) per scheduled DMRS port in a slot. Based on the indicated QCL information (e.g., the indication of a QCL Type E), a receiver (e.g., a UE) may exploit, or use, previously estimated (and stored) FD correlations or average PDPs per port by combining the previously estimated FD correlations or average PDPs for QCL'ed ports across slots (e.g., when the DMRS ports use the same, or equivalent, spatial precoders across these slots). Additionally, the UE has full control to fine-tune the FD correlation or average PDP for a current slot based on the history and time-separation of QCL'ed transmissions, e.g., to apply weights to stored FD correlations or average PDPs based on the time elapsed since they were computed and/or estimated. In some aspects, the type of QCL (e.g., the QCL Type E) may indicate a QCL source, but may also indicate for the UE to update the parameter associated with the QCL source.

An earlier DMRS port may be indicated to be a QCL source of a later DMRS port for a QCL Type E. A QCL reference signal (or QCL source), in some aspects, may be indicated using index types (e.g., an indexed list, or set, of classes having a same, or sufficiently similar, PDP) or slot pointers. The index types or the slot pointers may indicate, or be mapped to, one or more earlier physical downlink shared channel (PDSCH) transmissions whose DMRS ports are the QCL source (e.g., a QCL Type E of the later DMRS port). For example, a transmitter may include an indication of a QCL type for a particular signal (e.g., a DMRS) in a particular slot (e.g., slot m+n, n>0) with a previous slot (e.g., slot m). Based on the indication of the QCL type, the UE may perform a channel estimation using a combined estimated, or computed, PDP based on the particular signal in slot m+n and the QCL source (e.g., a DMRS in the slot m). For example, the UE may execute, or run time-domain filtering loops corresponding to the DMRS ports (e.g., the QCL'ed ports) and update loops for the scheduled ports in slot m+n.

As described above, a type of QCL (e.g., a QCL Type E or QCL Type E) may provide a mechanism (to indicate for a UE) to use earlier DMRS (e.g., DMRS received in one or more earlier slots) to estimate, or compute, a PDP (or average PDP) at a UE port and apply, or use, the estimated PDP to estimate, or compute a PDP of a later DMRS (where the estimated PDP of the later DMRS may be used for a channel estimation of, or associated with, the later DMRS). The QCL indication (for a QCL Type E) may include a field (e.g., a reference index field) including a value (or index) into an indexed set of QCL sources. The indexed set of QCL sources, in some aspects, may include a set of candidate slots that may be used as a QCL source (e.g., a reference slot for the QCL Type E). For example, for a QCL indication for a slot n, the reference index field may include x bits that may be used to indicate that the reference slot is one of a set of 2^{x} previous slots (e.g., slot n−2^{x} to slot n−1). If the field is one bit, the value may indicate whether the current slot is QCL'ed with an immediately previous slot or is not QCL'ed with the previous slot. The QCL indication (e.g., indicating a QCL Type E), in some aspects, may apply specifically to a DMRS or other specific signal such that referring to a slot as being QCL'ed with a reference slot may be understood as the DMRS in the slot being QCL'ed with a DMRS in the reference slot.

In some aspects, the indexed set of QCL sources may include an indexed set of candidate QCL classes that may be used to identify one or more QCL sources (e.g., one or more reference slots). For example, a particular value in the field of the QCL indication (indicating a particular class) may identify, or be used to identify, one or more reference slot(s) indicated, e.g., in a QCL indication for the one or more reference slot(s), to be associated with the same class. For the QCL indication (e.g., the QCL Type E indication), signals, channels, and/or ports having a same precoder (e.g., having a same precoder, or precoding matrix, applied by the transmitting device) may be considered, or assumed, to have identical FD correlations and PDPs. Generally, a transmitter such as a base station or network device may assume that, for a same set of physical conditions, the FD correlations and PDPs (or average FD correlations and average PDPs) of a signal, channel, and/or port may be based on, or related to, the precoder applied to the signal, channel, and/or port by the transmitter such that a FD correlation and/or PDP may be estimated based on the applied precoder.

When using either the set of candidate slots or candidate classes, the indication may indicate, or be mapped to, a particular stored PDP or filtered PDP (e.g., a PDP based on a single slot, or based on a filtering applied to a plurality of slots to refine a PDP estimation and/or computation). The filtered PDP may be the result of an infinite impulse response (IIR) filter, e.g., a first order IIR filter, PDP_{filtered}(slot_{current})=α*PDP_{filtered}(slot_{ref})+(1−α)*PDP(slot_{current}), where α (with 0≤α≤1) is a weight term indicating the relative contribution of a PDP estimated and/or computed based on a signal (e.g., a DMRS that may include a set of DMRS tones) received in a current slot (e.g., the PDP(slot_{current}) term for the current slot, slot_{current}) and a filtered PDP estimated and/or computed for a reference slot (e.g., the PDP_{filtered}(slot_{ref}) term for the reference slot, slot_{ref}) based on a signal (e.g., a DMRS) received in the reference slot and based on at least one signal(s) received in at least one previous slot(s) incorporated in, or used to estimate, or compute, the stored filtered PDP value. If the stored PDP is based on a single previous slot, the PDP_{filtered}(slot_{ref}) may be replaced with a PDP(slot_{ref}) term indicating that the stored PDP is based solely on the signal received in the reference slot.

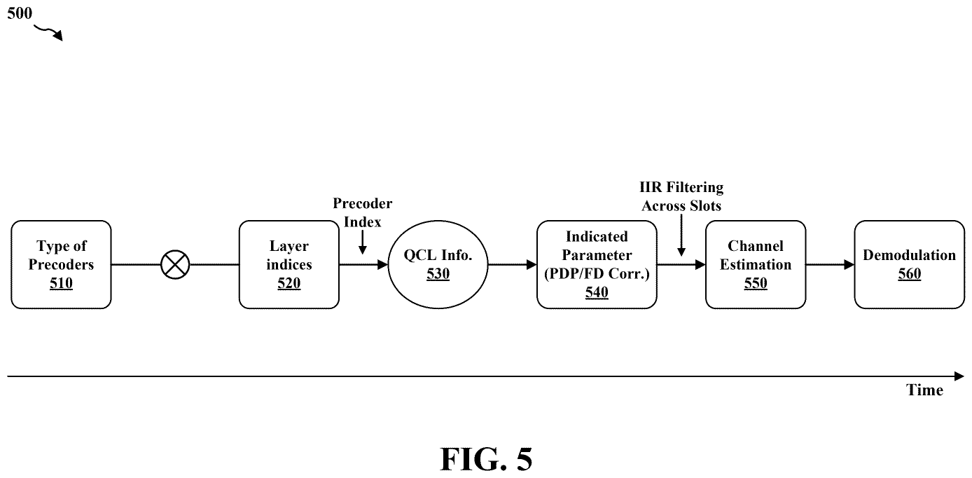

FIG. 5 is a diagram 500 illustrating aspects associated with an indication of a type of QCL of a first DMRS of a first port with a second DMRS of a second port in accordance with some aspects of the disclosure. Diagram 500 illustrates that a base station may take into account, or select, a type of precoder (e.g., from, or at, the type of precoders 510) and layer indices 520 to generate a set of precoder indexes (e.g., a QCL index class). The precoder index may be included in QCL information 530 (e.g., in an indication of a type of QCL, such as QCL Type E). In some aspects, the indicated QCL may be used to identify a stored parameter 540 (e.g., a FD correlation or PDP, where “parameter” as used here and below may refer to a characteristic of the channel and/or a set of values associated with the parameter/characteristic such as a set of data indicating a received power as a function of time delay) for a channel estimate. In some aspects the indication also indicates for the UE to perform a filtering operation (e.g., an IIR filtering based on the DMRS received in the current slot and the stored value identified by the indication of the type of QCL)/ The updated parameter (e.g., FD correlation or PDP) may then be used as an input to a channel estimation 550, which may, in turn, be used for a demodulation 560.

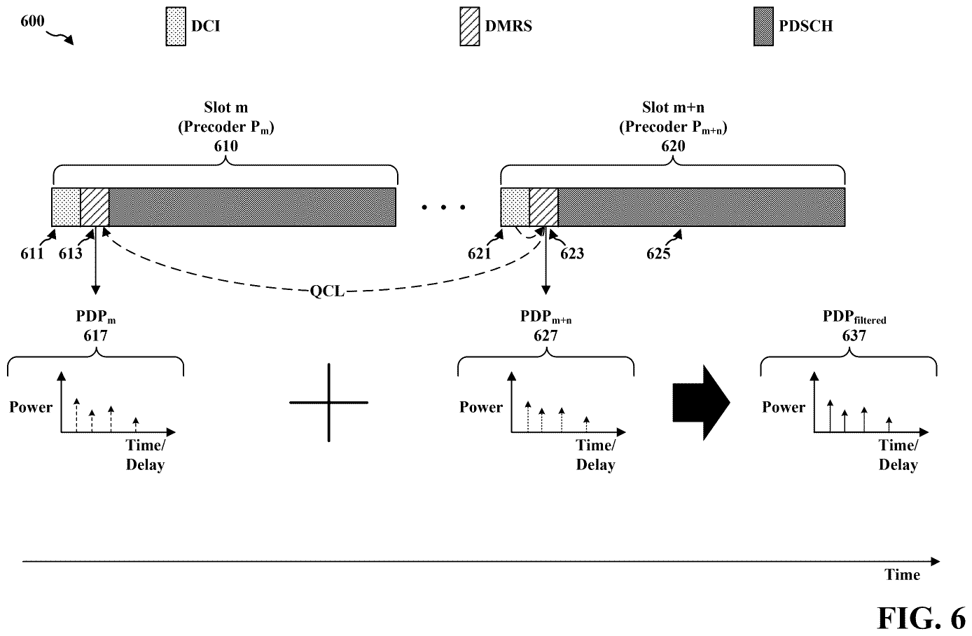

FIG. 6 is a diagram 600 illustrating some aspects of an indication of a type of QCL between a first DMRS and a second DMRS in accordance with some aspects of the disclosure. Diagram 600 illustrates that a slot 610 (e.g., slot m) may be received prior to a slot 620 (e.g., slot m+n) and that DCI 621 may indicate a QCL of DMRS 623 to DMRS 613 of slot 610. As a non-limiting example, the parameter indicated to be the same between the DMRS 623 and the DMRS 613 by the indication of the QCL is illustrated as being a PDP. The UE may retrieve a stored PDP (e.g., PDP 617) associated with the QCL index class and/or associated with the slot 610 (or, more specifically, the DMRS 623), and estimate and/or compute a PDP 627 based on the DMRS 623. The UE may then combine the retrieved PDP (e.g., PDP 617) and the estimated and/or computed PDP 627. In some aspects, the combination is based on a filter, e.g., an IIR filter, where the IIR filter may apply a function such as

$$P D {P}_{filtered} ( {slot}_{current} ) = α * P D {P}_{filtered} ( {slot}_{ref} ) + ( 1 - α ) *$$

PDP(slot_{current}), to arrive at PDP 637, where α (with 0≤α≤1) is a weight term indicating the relative contribution of a PDP estimated and/or computed based on a signal (e.g., a DMRS that may include a set of DMRS tones) received in a current slot (e.g., the PDP(slot_{current}) term for the current slot, slot_{current}) and a filtered PDP estimated and/or computed for a reference slot (e.g., the PDP_{filtered}(slot_{ref}) term for the reference slot, slot_{ref}) based on a signal (e.g., a DMRS) received in the reference slot and based on at least one signal(s) received in at least one previous slot(s) incorporated in, or used to estimate, or compute, the stored filtered PDP value. If the stored PDP is based on a single previous slot, the PDP_{filtered}(slot_{ref}) may be replaced with a PDP(slot_{ref}) term indicating that the stored PDP is based solely on the signal received in the reference slot. The PDP 637 (e.g., a filtered and/or updated PDP) may then be stored by the UE in association with the QCL index class indicated in DCI 611 or in association with the slot 620.

In some aspects, DCI 611 of slot 610 may have included an indication of a QCL to a previous slot (e.g., a slot m-n, not shown) such that the PDP 617 may be the result of a previous process similar to that described for slot 620. Accordingly, the UE may benefit from the filtering across multiple slots that produces a more accurate estimation or computation of PDP. When the more accurate PDP is used as an input to a channel estimation, the UE may benefit from an improved channel estimation. As described in relation to FIG. 5, the filtered and/or updated PDP 637 may be used for a channel estimation and eventually to demodulate and/or decode data 625 of the slot 620. The filtering and/or updating of the PDP (as an example of information used for channel estimation) may be indicated for the receiver (e.g., a UE) to perform by the type of QCL relationship (e.g., a QCL Type E

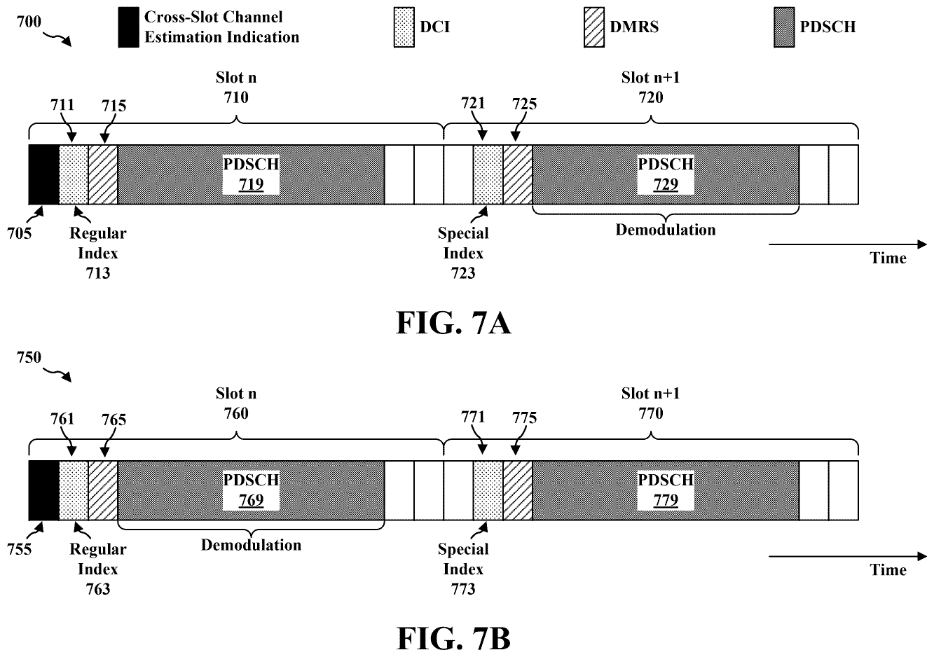

FIG. 7A is a diagram 700 illustrating a non-limiting example of a use of a special index for a type of QCL indication associated with a causal DMRS combining for a joint channel estimation in accordance with some aspects of the disclosure. For the following description it will be assumed that a base station transmits, and a UE receives, control signaling (e.g., DCI), reference signals (e.g., DMRSs), and data (e.g., in a PDSCH) using a set of ports. It is to be understood that the base station and UE are provided as non-limiting examples of a transmitting device (or transmitter) and a receiving device (or receiver), respectively. For ease of illustration, a first slot 710 is illustrated as including the indication of the joint channel estimation 705 associated with the first slot 710 (e.g., slot n) and a second slot 720 (e.g., slot n+1) and the DCI 711 including the indication of the type of QCL relationship between a first DMRS 715 (e.g., a set of DMRSs associated with a corresponding set of ports used to transmit the DMRS 715 and the PDSCH 719) in the first slot 710 and a first reference DMRS (or QCL class). Similarly, the second slot 720 is illustrated as including the DCI 721 including the indication of the type of QCL relationship between a second DMRS 725 (e.g., a set of DMRSs associated with a corresponding set of ports used to transmit the DMRS 725 and PDSCH 729) in the second slot 720 and a second reference DMRS (or QCL class). In practice, the indication of the joint channel estimation 705 (e.g., a cross-slot channel estimation), the DCI 711 associated with the first slot 710, and the DCI 721 associated with the second slot 720 may be received in slots that precede the associated slot by at least a first number of slots associated with a processing time for the indication. Additionally, in diagram 700 (and similar diagrams 750, 800, 850, and 900 of FIGS. 7B, 8A, 8B, and 9, respectively), while the indication of the joint channel estimation 705 is illustrated as being transmitted in a different symbol preceding the symbol including the DCI 711 and/or the indication of the type of QCL relationship, in some aspects, a same symbol and/or DCI may carry the indication of the joint channel estimation and the indication of the type of QCL relationship.

In some aspects, the DCI 711 can use a regular index 713 for the first slot 710 to indicate a QCL Type E source for the first slot 710 (or the DMRS 715) and the DCI 721 can use a special index 723 to indicate a QCL Type E source for the second slot 720 (or the DMRS 725) in association with a causal DMRS combining between the first slot 710 and the second slot 720 (which may be referred to as a slot ‘n’ and a slot ‘n+1’, respectively). The regular index 713, in some aspects, may be a value (or index) into an indexed set of QCL sources (as described above in relation to the candidate slots or candidate classes) that may be indicated by, or included in, a first set of bits or a first field in the DCI 711. In some aspects, the special index 723 may be a single bit or a second field in the DCI 721 that precedes the first set of bits and indicates (e.g., via a first bit value, such as a “0” or “1” value, for the special index) that the QCL reference for the second DMRS 725 and/or the second slot 720 is the first DMRS 715 and/or the first slot 710. In some aspects, the single bit associated with the special index may indicate whether to determine a QCL source for a DMRS based on the first set of bits (e.g., via a regular index included in the first set of bits) of an associated DCI (e.g., a DCI scheduling the transmission of the PDSCH/DMRS during the associated slot) or whether the QCL source for the DMRS is the DMRS of the slot indicated for the joint channel estimation (or a same QCL source indicated for the DMRS and/or the slot indicated for the joint channel estimation by the regular index in the DCI associated with the slot indicated for the joint channel estimation).

As described above, for the first slot 710, a UE may receive an indication to perform causal combining with the second slot 720. While illustrated as separate from the DCI 711, the indication of the joint channel estimation 705 may be included in the DCI 711 for the first slot 710. The indication of the joint channel estimation 705, in some aspects, may instruct the UE to store the raw signals, or tones, associated with the first DMRS 715 to use to perform the joint channel estimation for the second slot 720. In some aspects, an indication of a joint channel estimation may indicate whether the joint channel estimation is a casual or non-causal the joint channel estimation.

In some aspects, the UE may estimate, or compute, information (e.g., a PDP or FD correlation) associated with the first slot 710 based on the raw channel (e.g., the raw signals, or tones, associated with the first DMRS 715). The UE, in some aspects, may update (stored) information for channel estimation associated with the regular index 713 and store the updated information. The UE may perform the channel estimation for (a demodulation of) the first slot 710 (e.g., the PDSCH 719) using the stored information before or after performing the update to the information based on the DMRS 715 of the first slot 710 (i.e., the UE may use either the retrieved information or the updated information). For example, the UE may update (or initialize) a stored PDP (e.g., a stored PDP associated with a reference slot or QCL class indicated by the regular index 713) based on a combining operation performed on the stored PDP and the estimated/computed PDP associated with the first slot 710 and perform a channel estimation based on one of the stored PDP or the updated PDP based on the combining operation. The combining operation, in some aspects, may be (as non-limiting examples) a loop filter/filtering, an IIR filter/filtering, or any other combining operation determined by, or configured for, the UE.

For the second slot 720, the UE may estimate, or compute, information (e.g., a PDP or FD correlation) associated with the second slot 720 based on the raw channel (e.g., the raw signals, or tones, associated with the second DMRS 725). The UE, in some aspects, may update the stored information for channel estimation associated with the special index 723 (e.g., the stored information identified, or indicated, by the regular index 713 and updated based on the first DMRS 715) and store the updated information. The UE may perform the joint channel estimation for (a demodulation of) the second slot 720 based on the first DMRS 715 and the second DMRS 725 using the stored information before or after performing the update to the information based on the DMRS 725 of the second slot 720 (i.e., the UE may use either the retrieved information or the updated information). For example, the UE may identify the DCI 721 as including a special index 723 and identify a stored PDP associated with the first slot 710 (e.g., associated with a reference slot or QCL class indicated by the regular index 713). The UE may then update the stored PDP (e.g., the PDP updated based on the first DMRS 715) based on a combining operation performed on the stored PDP and the estimated/computed PDP associated with the second slot 720 and store the updated PDP in association with one of the second slot 720 as a reference slot or the QCL class indicated by the regular index 713 (which is implicitly indicated by the special index 723). The combining operation, in some aspects, may be (as non-limiting examples) a loop filter/filtering, an IIR filter/filtering, or any other combining operation determined by, or configured for, the UE. The UE may also perform a joint channel estimation based on the first DMRS 715 and the second DMRS 725 using, or based on, one of the stored/retrieved PDP or the updated PDP (e.g., updated based on the combining operation). Based on the joint channel estimation, the UE may then perform the demodulation of the PDSCH 729.

FIG. 7B is a diagram 750 illustrating a non-limiting example of a use of a special index for a type of QCL indication associated with a non-causal DMRS combining for a joint channel estimation in accordance with some aspects of the disclosure. For the following description it will be assumed that a base station transmits, and a UE receives, control signaling (e.g., DCI), reference signals (e.g., DMRSs), and data (e.g., in a PDSCH) using a set of ports. It is to be understood that the base station and UE are provided as non-limiting examples of a transmitting device (or transmitter) and a receiving device (or receiver), respectively. For ease of illustration, a first slot 760 is illustrated as including the indication of the joint channel estimation 755 associated with a first slot 760 (e.g., slot n) and a second slot 770 (e.g., slot n+1) and the DCI 761 including the indication of the type of QCL relationship between a first DMRS 765 (e.g., a set of DMRSs associated with a corresponding set of ports used to transmit the DMRS 765 and the PDSCH 769) in the first slot 760 and a first reference DMRS (or QCL class). Similarly, the second slot 770 is illustrated as including the DCI 771 including the indication of the type of QCL relationship between a second DMRS 775 (e.g., a set of DMRSs associated with a corresponding set of ports used to transmit the DMRS 775 and PDSCH 779) in the second slot 770 and a second reference DMRS (or QCL class). In practice, the indication of the joint channel estimation 755 (e.g., a cross-slot channel estimation), the DCI 761 associated with the first slot 760, and the DCI 771 associated with the second slot 770 may be received in slots that precede the associated slot by at least a first number of slots associated with a processing time for the indication.

In some aspects, the DCI 761 can use a regular index 763 for the first slot 760 to indicate a QCL Type E source for the first slot 760 (or the DMRS 765) and the DCI 771 can use a special index 773 to indicate a QCL Type E source for the second slot 770 (or the DMRS 775) in association with a non-causal DMRS combining between the first slot 760 and the second slot 770 (which may be referred to as a slot ‘n’ and a slot ‘n+1’, respectively). The regular index 763, in some aspects, may be a value (or index) into an indexed set of QCL sources (as described above in relation to the candidate slots or candidate classes) that may be indicated by, or included in, a first set of bits or a first field in the DCI 761. In some aspects, the special index 773 may be a single bit or a second field in the DCI 771 that precedes the first set of bits and indicates (e.g., via a first bit value, such as a “0” or “1” value, for the special index) that the QCL reference for the second DMRS 775 and/or the second slot 770 is the first DMRS 765 and/or the first slot 760. In some aspects, the single bit associated with the special index may indicate whether to determine a QCL source for a DMRS based on the first set of bits (e.g., via a regular index included in the first set of bits) of an associated DCI (e.g., a DCI scheduling the transmission of the PDSCH/DMRS during the associated slot) or whether the QCL source for the DMRS is the DMRS of the slot indicated for the joint channel estimation (or a same QCL source indicated for the DMRS and/or the slot indicated for the joint channel estimation by the regular index in the DCI associated with the slot indicated for the joint channel estimation).

As described above, for the first slot 760, a UE may receive an indication to perform non-causal combining with the second slot 770. While illustrated as separate from the DCI 761, the indication of the joint channel estimation 755 may be included in the DCI 761 for the first slot 760. The indication of the joint channel estimation 755, in some aspects, may instruct the UE to store the raw signals, or tones, associated with the first DMRS 765 and the raw signals, or tones, associated with the PDSCH 769 to use to perform the joint channel estimation for at least the first slot 760.

In some aspects, the UE may estimate, or compute, information (e.g., a PDP or FD correlation) associated with the first slot 760 based on the raw channel (e.g., the raw signals, or tones, associated with the first DMRS 765). The UE, in some aspects, may update (stored) information for channel estimation associated with the regular index 763 and store the updated information. Similarly, for the second slot 770, the UE may estimate, or compute, information (e.g., a PDP or FD correlation) associated with the second slot 770 based on the raw channel (e.g., the raw signals, or tones, associated with the second DMRS 775). The UE, in some aspects, may update the stored information for channel estimation associated with the special index 773 (e.g., the stored information identified, or indicated, by the regular index 763 and updated based on the first DMRS 765) and store the updated information. The UE may perform the joint channel estimation for (a demodulation of) at least the first slot 760 based on the first DMRS 765 and the second DMRS 775 using the stored information before or after performing the update to the information based on the DMRS 775 of the second slot 770 (i.e., the UE may use either the retrieved information or the updated information).

For example, based on the DCI 761 including the regular index 763, the UE may update (or initialize) a stored PDP (e.g., a stored PDP associated with a reference slot or QCL class indicated by the regular index 763) based on a combining operation performed on the stored PDP and the estimated/computed PDP associated with the first slot 760. The combining operation, in some aspects, may be (as non-limiting examples) a loop filter/filtering, an IIR filter/filtering, or any other combining operation determined by, or configured for, the UE. The UE may then identify the DCI 771 as including a special index 773 and identify a stored PDP associated with the first slot 760 (e.g., associated with a reference slot or QCL class indicated by the regular index 763). The UE may then update the stored PDP (e.g., the PDP updated based on the first DMRS 765) based on a combining operation performed on the stored PDP and the estimated/computed PDP associated with the second slot 770 and store the updated PDP in association with one of the second slot 770 as a reference slot or the QCL class indicated by the regular index 763 (which is implicitly indicated by the special index 773). The combining operation, in some aspects, may be (as non-limiting examples) a loop filter/filtering, an IIR filter/filtering, or any other combining operation determined by, or configured for, the UE. The UE may also perform a joint channel estimation based on the first DMRS 765 and the second DMRS 775 using, or based on, one of the stored/retrieved PDP or the updated PDP (e.g., updated based on the combining operation). Based on the joint channel estimation, the UE may then perform the demodulation of the PDSCH 769 of the first slot 760.

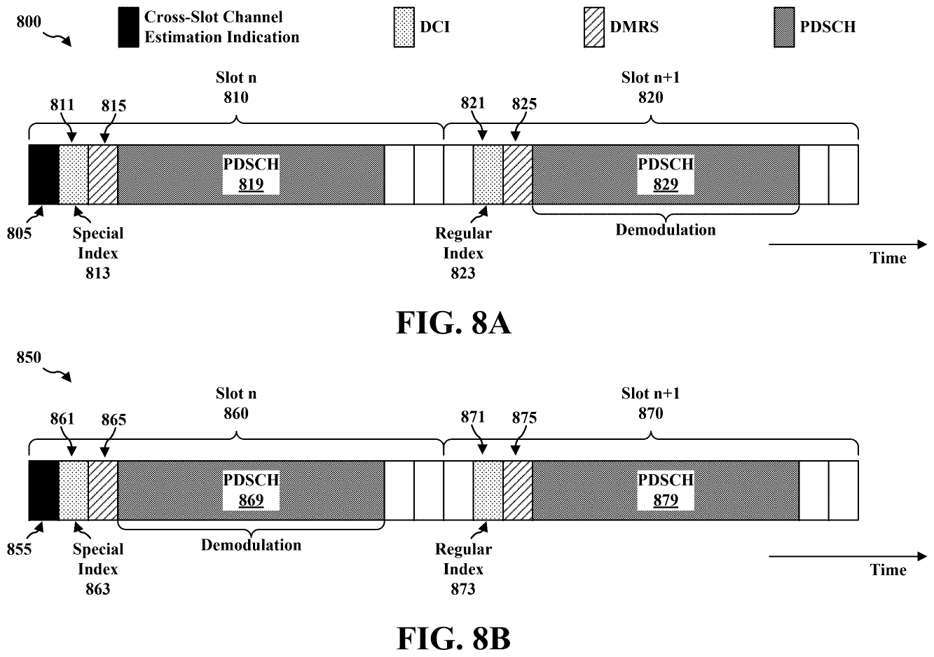

FIG. 8A is a diagram 800 illustrating a non-limiting example of a use of a special index for a type of QCL indication associated with a causal DMRS combining for a joint channel estimation in accordance with some aspects of the disclosure. For the following description it will be assumed that a base station transmits, and a UE receives, control signaling (e.g., DCI), reference signals (e.g., DMRSs), and data (e.g., in a PDSCH) using a set of ports. It is to be understood that the base station and UE are provided as non-limiting examples of a transmitting device (or transmitter) and a receiving device (or receiver), respectively. For ease of illustration, a first slot 810 is illustrated as including the indication of the joint channel estimation 805 associated with the first slot 810 (e.g., slot n) and a second slot 820 (e.g., slot n+1) and the DCI 811 including the indication of the type of QCL relationship between a first DMRS 815 (e.g., a set of DMRSs associated with a corresponding set of ports used to transmit the DMRS 815 and the PDSCH 819) in the first slot 810 and a first reference DMRS (or QCL class). Similarly, the second slot 820 is illustrated as including the DCI 821 including the indication of the type of QCL relationship between a second DMRS 825 (e.g., a set of DMRSs associated with a corresponding set of ports used to transmit the DMRS 825 and PDSCH 829) in the second slot 820 and a second reference DMRS (or QCL class). In practice, the indication of the joint channel estimation 805 (e.g., a cross-slot channel estimation), the DCI 811 associated with the first slot 810, and the DCI 821 associated with the second slot 820 may be received in slots that precede the associated slot by at least a first number of slots associated with a processing time for the indication.

In some aspects, the indication of the joint channel estimation 805 may be omitted based on, or may be indicated by, the use of the special index 813. For example, the special index 813 included in the DCI 811 may indicate a causal DMRS combining with a next slot and may indicate to the UE to perform the update of the information (e.g., a PDP or FD correlation) for the channel estimation based on one of the DMRS in the next slot, or a reference DMRS (or QCL class) indicated by a regular index included in the DCI associated with the next slot (e.g., a regular index 823 included in DCI 821). The special index 813 may be used as, or in place of, the indication of the joint channel estimation 805 to reduce signaling overhead and a base station may save additional signaling overhead by omitting the regular index 823 from the DCI 821 at the cost of not being able to benefit from identifying a QCL source updated across slots other than the first slot 810 and the second slot 820.

In some aspects, the DCI 811 can use a special index 813 for the first slot 810 to indicate a QCL Type E source for the first slot 810 (or the DMRS 815) and the DCI 821 can use a regular index 823 to indicate a QCL Type E source for the second slot 820 (or the DMRS 825) in association with a causal DMRS combining between the first slot 810 and the second slot 820 (which may be referred to as a slot ‘n’ and a slot ‘n+1’, respectively). The special index 813, in some aspects, may be a first set of bits, e.g., a first field associated with a single bit, in the DCI 811 that precedes a second set of bits and indicates (e.g., via a first bit value, such as a “0” or “1” value, for the special index) that the QCL reference for the first DMRS 815 and/or the first slot 810 is the second DMRS 825 and/or the second slot 820 (or a QCL source identified for the second DMRS 825 and/or the second slot 820). In some aspects, the single bit associated with the special index may indicate whether to determine a QCL source for a DMRS based on the second set of bits (e.g., via a regular index included in the second set of bits) of an associated DCI (e.g., a DCI scheduling the transmission of the PDSCH/DMRS during the associated slot) or whether the QCL source for the DMRS is the DMRS of the slot indicated for the joint channel estimation (or a same QCL source indicated for the DMRS and/or the slot indicated for the joint channel estimation by the regular index in the DCI associated with the slot indicated for the joint channel estimation). In some aspects, the regular index 823 may be a value (or index) into an indexed set of QCL sources (as described above in relation to the candidate slots or candidate classes) that may be indicated by, or included in, the second set of bits or a second field in the DCI 821.

As described above, for the first slot 810, a UE may receive an indication to perform causal combining with the second slot 820. While illustrated as separate from the DCI 811, the indication of the joint channel estimation 805 may be included in the DCI 811 for the first slot 810. The indication of the joint channel estimation 805, in some aspects, may instruct the UE to store the raw signals, or tones, associated with the first DMRS 815 to use to perform the joint channel estimation for the second slot 820.

In some aspects, the UE may estimate, or compute, information (e.g., a PDP or FD correlation) associated with the first slot 810 based on the raw channel (e.g., the raw signals, or tones, associated with the first DMRS 815). The UE, in some aspects, may update (stored) information for channel estimation associated with the special index 813 and store the updated information. In aspects not using the regular index 823 included in the DCI 821 associated with the second slot 820 to indicate a QCL source for the first slot 810, the UE may update the information by initializing the stored information for updating based on the DMRS 825 of the second slot 820. In aspects using the regular index 823 included in the DCI 821 associated with the second slot 820 to indicate a QCL source for the first slot 810, the UE may update stored information associated with the QCL source based on the first DMRS 815 (e.g., the estimated, or computed, information based on the first DMRS 815). The UE may perform the channel estimation for (a demodulation of) the first slot 810 (e.g., the PDSCH 819) using the estimated, or computed information or based on stored information identified based on the regular index 823 before or after performing the update to the information based on the DMRS 815 of the first slot 810 (i.e., the UE may use either the retrieved information or the updated information). For example, the UE may update (or initialize) a stored PDP (e.g., a stored PDP associated with a reference slot or QCL class indicated by the special index 813 and/or the regular index 823) based on a combining operation performed on the stored PDP and the estimated/computed PDP associated with the first slot 810 and perform a channel estimation based on one of the stored PDP or the updated PDP based on the combining operation. The combining operation, in some aspects, may be (as non-limiting examples) a loop filter/filtering, an IIR filter/filtering, or any other combining operation determined by, or configured for, the UE.

For the second slot 820, the UE may estimate, or compute, information (e.g., a PDP or FD correlation) associated with the second slot 820 based on the raw channel (e.g., the raw signals, or tones, associated with the second DMRS 825). The UE, in some aspects, may update the stored information for channel estimation associated with the regular index 823 (e.g., the stored information identified, or indicated, by the regular index 823 and updated based on the first DMRS 815) and store the updated information. The UE may perform the joint channel estimation for (a demodulation of) the second slot 820 based on the first DMRS 815 and the second DMRS 825 using the stored information before or after performing the update to the information based on the DMRS 825 of the second slot 820 (i.e., the UE may use either the retrieved information or the updated information). For example, the UE may identify the DCI 821 as including a regular index 823 and identify a stored PDP associated with the second slot 820 (e.g., associated with a reference slot or QCL class indicated by the regular index 823). The UE may then update the stored PDP (e.g., the PDP updated based on the first DMRS 815) based on a combining operation performed on the stored PDP and the estimated/computed PDP associated with the second slot 820 and store the updated PDP in association with one of the second slot 820 as a reference slot or the QCL class indicated by the regular index 823. The combining operation, in some aspects, may be (as non-limiting examples) a loop filter/filtering, an IIR filter/filtering, or any other combining operation determined by, or configured for, the UE. The UE may also perform a joint channel estimation based on the first DMRS 815 and the second DMRS 825 using, or based on, one of the stored/retrieved PDP or the updated PDP (e.g., updated based on the combining operation). Based on the joint channel estimation, the UE may then perform the demodulation of the PDSCH 829 of the second slot 820.

FIG. 8B is a diagram 850 illustrating a non-limiting example of a use of a special index for a type of QCL indication associated with a non-causal DMRS combining for a joint channel estimation in accordance with some aspects of the disclosure. For the following description it will be assumed that a base station transmits, and a UE receives, control signaling (e.g., DCI), reference signals (e.g., DMRSs), and data (e.g., in a PDSCH) using a set of ports. It is to be understood that the base station and UE are provided as non-limiting examples of a transmitting device (or transmitter) and a receiving device (or receiver), respectively. For ease of illustration, a first slot 860 is illustrated as including the indication of the joint channel estimation 855 associated with a first slot 860 (e.g., slot n) and a second slot 870 (e.g., slot n+1) and the DCI 861 including the indication of the type of QCL relationship between a first DMRS 865 (e.g., a set of DMRSs associated with a corresponding set of ports used to transmit the DMRS 865 and the PDSCH 869) in the first slot 860 and a first reference DMRS (or QCL class). Similarly, the second slot 870 is illustrated as including the DCI 871 including the indication of the type of QCL relationship between a second DMRS 875 (e.g., a set of DMRSs associated with a corresponding set of ports used to transmit the DMRS 875 and PDSCH 879) in the second slot 870 and a second reference DMRS (or QCL class). In practice, the indication of the joint channel estimation 855 (e.g., a cross-slot channel estimation), the DCI 861 associated with the first slot 860, and the DCI 871 associated with the second slot 870 may be received in slots that precede the associated slot by at least a first number of slots associated with a processing time for the indication.

In some aspects, the indication of the joint channel estimation 855 may be omitted based on, or may be indicated by, the use of the special index 863. For example, the special index 863 included in the DCI 861 may indicate a non-causal DMRS combining with a next slot and may indicate to the UE to perform the update of the information (e.g., a PDP or FD correlation) for the channel estimation based on one of the DMRS in the next slot, or a reference DMRS (or QCL class) indicated by a regular index included in the DCI associated with the next slot (e.g., a regular index 873 included in DCI 871). The special index 863 may be used as, or in place of, the indication of the joint channel estimation 855 to reduce signaling overhead and a base station may save additional signaling overhead by omitting the regular index 873 from the DCI 871 at the cost of not being able to benefit from identifying a QCL source updated across slots other than the first slot 860 and the second slot 870.

In some aspects, the DCI 861 can use a special index 863 for the first slot 860 to indicate a QCL Type E source for the first slot 860 (or the DMRS 865) and the DCI 871 can use a regular index 873 to indicate a QCL Type E source for the second slot 870 (or the DMRS 875) in association with a non-causal DMRS combining between the first slot 860 and the second slot 870 (which may be referred to as a slot ‘n’ and a slot ‘n+1’, respectively). The special index 863, in some aspects, may be a first set of bits, e.g., a first field associated with a single bit, in the DCI 861 that precedes a second set of bits and indicates (e.g., via a first bit value, such as a “0” or “1” value, for the special index) that the QCL reference for the first DMRS 865 and/or the first slot 860 is the second DMRS 875 and/or the second slot 870 (or a QCL source identified for the second DMRS 875 and/or the second slot 870). In some aspects, the single bit associated with the special index may indicate whether to determine a QCL source for a DMRS based on the second set of bits (e.g., via a regular index included in the second set of bits) of an associated DCI (e.g., a DCI scheduling the transmission of the PDSCH/DMRS during the associated slot) or whether the QCL source for the DMRS is the DMRS of the slot indicated for the joint channel estimation (or a same QCL source indicated for the DMRS and/or the slot indicated for the joint channel estimation by the regular index in the DCI associated with the slot indicated for the joint channel estimation). In some aspects, the regular index 873 may be a value (or index) into an indexed set of QCL sources (as described above in relation to the candidate slots or candidate classes) that may be indicated by, or included in, the second set of bits or a second field in the DCI 871.

As described above, for the first slot 860, a UE may receive an indication to perform non-causal combining with the second slot 870. While illustrated as separate from the DCI 861, the indication of the joint channel estimation 855 may be included in the DCI 861 for the first slot 860. The indication of the joint channel estimation 855, in some aspects, may instruct the UE to store the raw signals, or tones, associated with the first DMRS 865 and the raw signals, or tones, associated with the PDSCH 869 to use to perform the joint channel estimation for at least the first slot 860.

In some aspects, the UE may estimate, or compute, information (e.g., a PDP or FD correlation) associated with the first slot 860 based on the raw channel (e.g., the raw signals, or tones, associated with the first DMRS 865). The UE, in some aspects, may update (stored) information for channel estimation associated with the special index 863 and store the updated information. In aspects not using the regular index 873 included in the DCI 871 associated with the second slot 870 to indicate a QCL source for the first slot 860, the UE may update the information by initializing the stored information for updating based on the DMRS 875 of the second slot 870. In aspects using the regular index 873 included in the DCI 871 associated with the second slot 870 to indicate a QCL source for the first slot 860, the UE may update stored information associated with the QCL source based on the first DMRS 865 (e.g., the estimated, or computed, information based on the first DMRS 865). Similarly, for the second slot 870, the UE may estimate, or compute, information (e.g., a PDP or FD correlation) associated with the second slot 870 based on the raw channel (e.g., the raw signals, or tones, associated with the second DMRS 875). The UE, in some aspects, may update the stored information for channel estimation associated with the regular index 873 (e.g., the stored information identified, or indicated, by the regular index 873 and updated based on the first DMRS 865) and store the updated information. The UE may perform the joint channel estimation for (a demodulation of) at least the first slot 860 based on the first DMRS 865 and the second DMRS 875 using the stored information before or after performing the update to the information based on the DMRS 875 of the second slot 870 (i.e., the UE may use either the retrieved information or the updated information).

For example, based on the DCI 861 including the special index 863, the UE may update (or initialize) a stored PDP (e.g., a stored PDP associated with a reference slot or QCL class indicated by the special index 863 and/or the regular index 873) based on a combining operation performed on the stored PDP and the estimated/computed PDP associated with the first slot 860. The combining operation, in some aspects, may be (as non-limiting examples) a loop filter/filtering, an IIR filter/filtering, or any other combining operation determined by, or configured for, the UE. The UE may then identify the DCI 871 as including a regular index 873 and identify a stored PDP associated with the second slot 870 (e.g., associated with a reference slot or QCL class indicated by the regular index 873). The UE may then update the stored PDP (e.g., the PDP updated based on the first DMRS 865) based on a combining operation performed on the stored PDP and the estimated/computed PDP associated with the second slot 870 and store the updated PDP in association with one of the second slot 870 as a reference slot or the QCL class indicated by the regular index 873. The combining operation, in some aspects, may be (as non-limiting examples) a loop filter/filtering, an IIR filter/filtering, or any other combining operation determined by, or configured for, the UE. The UE may also perform a joint channel estimation based on the first DMRS 865 and the second DMRS 875 using, or based on, one of the stored/retrieved PDP or the updated PDP (e.g., updated based on the combining operation). Based on the joint channel estimation, the UE may then perform the demodulation of the PDSCH 869 of the first slot 860.

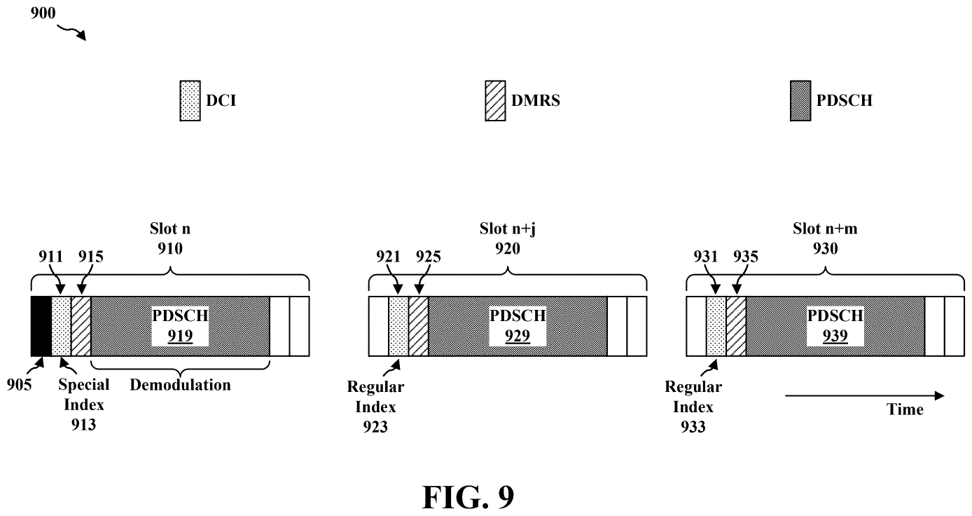

FIG. 9 is a diagram 900 illustrating a non-limiting example of a use of a special index for a type of QCL indication associated with a non-causal DMRS combining for a joint channel estimation across a plurality of slots in accordance with some aspects of the disclosure. The joint channel estimation across a plurality of slots may be associated with a non-causal DMRS combining associated with, and/or a demodulation of, at least a first slot 910 (e.g., slot n) in a plurality of slots including a second slot 920 (e.g., slot n+j) and a third slot 930 (e.g., a slot n+m) where the plurality of slots includes m additional slots after the first slot 910. For the following description it will be assumed that a base station transmits, and a UE receives, control signaling (e.g., DCI), reference signals (e.g., DMRSs), and data (e.g., in a PDSCH) using a set of ports. It is to be understood that the base station and UE are provided as non-limiting examples of a transmitting device (or transmitter) and a receiving device (or receiver), respectively. For ease of illustration, the first slot 910 is illustrated as including the indication of the joint channel estimation 905 and the DCI 911 including the indication of the type of QCL relationship between a first DMRS 915 (e.g., a set of DMRSs associated with a corresponding set of ports used to transmit the DMRS 915 and the PDSCH 919) in the first slot 910 and a first reference DMRS (or QCL class). Similarly, the second slot 920 is illustrated as including the DCI 921 including the indication of the type of QCL relationship between a second DMRS 925 (e.g., a set of DMRSs associated with a corresponding set of ports used to transmit the DMRS 925 and PDSCH 929) in the second slot 920 and a second reference DMRS (or QCL class). The third slot 930 is illustrated as including the DCI 931 including the indication of the type of QCL relationship between a third DMRS 935 (e.g., a set of DMRSs associated with a corresponding set of ports used to transmit the DMRS 935 and PDSCH 939) in the third slot 930 and a third reference DMRS (or QCL class). In practice, the indication of the joint channel estimation 905 (e.g., a cross-slot channel estimation), the DCI 911 associated with the first slot 910, the DCI 921 associated with the second slot 920, and the DCI 931 associated with the third slot 930 may be received in slots that precede the associated slot by at least a first number of slots associated with a processing time for the indication.

The joint channel estimation 905, in some aspects, may indicate a non-causal combining but may not indicate the number of slots for the non-causal combining, while the special index 913 may indicate the number of slots (via a sub-index or a value m, for m∈{1, 2, 3, . . . , M} of the special index). In some aspects, the maximum number of slots, M, that may be indicated in the special index may be an RRC configured value and may be based on a UE capability reported by the UE to the base station. The number of bits associated with the special index may be based, at least in part, on the maximum number of slots M and may further be based on the number of selectable values from 1 to M.

In some aspects, the indication of the joint channel estimation may be omitted based on, or may be indicated by, the use of the special index 913. For example, the special index 913 included in the DCI 911 may indicate (e.g., via a value, m, in a first set of bits) a non-causal DMRS combining with a next ‘m’ slots and may indicate to the UE to perform the update of the information (e.g., a PDP or FD correlation) for the channel estimation based on one of the DMRS in the next slot, or a reference DMRS (or QCL class) indicated by a regular index included in the DCI associated with at least one slot of the next ‘m’ slots (e.g., a regular index 923 included in DCI 921 or a regular index 933 included in DCI 931). The special index 913 may be used as, or in place of, the indication of the joint channel estimation to reduce signaling overhead and a base station may save additional signaling overhead by omitting the regular index from the DCI for subsequent slots at the cost of not being able to benefit from identifying a QCL source updated across slots other than the slots associated with the joint channel estimation.

In some aspects, the DCI 911 can use a special index 913 for the first slot 910 to indicate a QCL Type E source for the first slot 910 (or the DMRS 915), the DCI 921 can use a regular index 923 to indicate a QCL Type E source for the second slot 920 (or the DMRS 925), and the DCI 931 can use a regular index 933 to indicate a QCL Type E source for the third slot 930 (or the DMRS 935) in association with a non-causal DMRS combining between, or for, the plurality of slots including the first slot 910, the second slot 920, and the third slot 930 (which may be referred to as a slot ‘n’, a slot ‘n+j’, and a slot ‘n+m’, respectively). In some aspects, the regular indexes in each of the m additional slots may indicate a same QCL source. In some aspects, the regular index 923 and/or the regular index 933 may be a value (or index) into an indexed set of QCL sources (as described above in relation to the candidate slots or candidate classes). The special index 913, in some aspects, may be a first set of bits, e.g., a first field associated with two or more bits, in DCI 911 that indicates (e.g., via a first value m, for m∈{1, 2, 3, . . . , M} for the special index) that the QCL reference for the first DMRS 915 and/or the first slot 910 is the additional DMRSs associated with the plurality of slots (e.g., slots n+1 to the slot n+m) and/or a QCL source identified for the plurality of slots. For example, the special index 913 may indicate that the QCL source for the first DMRS 915 and/or the first slot 910 is a QCL source indicated by a regular index (e.g., regular index 923 and/or regular index 933) included in at least one of the plurality of slots (e.g., slots n+1 to the slot n+m).

Within each DCI occasion, a first set of bits associated with the special index may precede a second set of bits (e.g., a second field) associated with a regular index. In some aspects, the first set of bits or the first field associated with the special index may indicate whether to determine a QCL source for a DMRS based on the second set of bits (e.g., via a regular index included in the second set of bits) of an associated DCI (e.g., a DCI scheduling the transmission of the PDSCH/DMRS during the associated slot) or whether the QCL source for the DMRS is the DMRS of the slot indicated for the joint channel estimation (or a same QCL source indicated for the DMRS and/or the slot indicated for the joint channel estimation by the regular index in the DCI associated with the slot indicated for the joint channel estimation). For example, if the first set of bits, e.g., a first field, indicates a value 0, the UE may identify that the special index does not indicate a QCL source and that the regular index included in the second set of bits or a second field in the DCI is used to indicate the QCL source. In some aspects, the regular index may be a value (or index) into an indexed set of QCL sources (as described above in relation to the candidate slots or candidate classes).

As described above, for the first slot 910, a UE may receive an indication to perform non-causal combining with the second slot 920. While illustrated as separate from the DCI 911, the indication of the joint channel estimation may be included in the DCI 911 for the first slot 910. The indication of the joint channel estimation, in some aspects, may instruct the UE to store the raw signals, or tones, associated with the first DMRS 915 and raw signals, or tones, associated with the PDSCH 919 to use in performing the joint channel estimation for at least the first slot 910.

In some aspects, the UE may estimate, or compute, information (e.g., a PDP or FD correlation) associated with the first slot 910 based on the raw channel (e.g., the raw signals, or tones, associated with the first DMRS 915). The UE, in some aspects, may update (stored) information for channel estimation associated with the special index 913 and store the updated information. In aspects not using the regular index 923 included in the DCI 921 associated with the second slot 920 (or a regular index in any of the m additional slots) to indicate a QCL source for the first slot 910, the UE may update the information by initializing the stored information for updating based on the additional DMRSs in the additional slots (e.g., including DMRS 925 of the second slot 920 and DMRS 935 of the third slot 930). In aspects using the regular index 923 included in the DCI 921 associated with the second slot 920 to indicate a QCL source for the first slot 910, the UE may update stored information associated with the QCL source based on the first DMRS 915 (e.g., the estimated, or computed, information based on the first DMRS 915). Similarly, for the subsequent slots (e.g., the m additional slots), the UE may for slot n+i (for i∈{1, 2, 3, . . . , m} (estimate, or compute, information (e.g., a PDPᵢ or FD correlation) associated with the slot based on the raw channel (e.g., the raw signals, or tones, associated with the DMRS associated with the slot) and update the stored information (e.g., for each slot, n+i, an estimated PDP, PDPᵢ, may be used to updated a stored PDP, PDP_{filtered,i}, based on a combining operations such as PDP_{filtered,i}=α*PDP_{filtered,i-1}+(1−α)*PDPᵢ)). For example, referring to the second slot 920, the UE may estimate, or compute, information (e.g., a PDPᵢ₊ⱼ) associated with the second slot 920 based on the raw channel (e.g., the raw signals, or tones, associated with the second DMRS 925) and the UE may update the stored information (e.g., PDPᵢ₊ⱼ₋₁) for channel estimation associated with the regular index 923 (e.g., the stored information identified, or indicated, by the regular index 923 and updated based on the first DMRS 915 and DMRSs in any intervening slots) and store the updated information. The UE may perform the joint channel estimation for (a demodulation of) at least the first slot 910 based on the DMRSs included in the plurality of slots (e.g., including the first DMRS 915 and the DMRSs included in the m additional slots) and using the stored information (e.g., the information produced by the updates based on the DMRSs included in the plurality of slots).

For example, based on the DCI 911 including the special index 913, the UE may update (or initialize) a stored PDP (e.g., a stored PDP associated with a reference slot or QCL class indicated by the special index 913 and/or the regular index 923 which may be referred to as a PDP_{QCL source}) based on a combining operation performed on the stored PDP, PDP_{QCL source}, and the estimated/computed PDP, PDP₀, associated with the first slot 910 to produce an initialized, or updated PDP_{QCL source}. The combining operation, in some aspects, may be (as non-limiting examples) a loop filter/filtering, an IIR filter/filtering, or any other combining operation determined by, or configured for, the UE. The UE may then identify a DCI associated with a next slot (e.g., slot n+1) as including a regular index and identify a stored PDP associated with the next slot (e.g., associated with a reference slot or QCL class indicated by the regular index indicated for slot n+1). The UE may then update the stored PDP (e.g., the PDP_{QCL source} updated based on the first DMRS 915) based on the combining operation performed on the stored PDP and the estimated/computed PDP associated with the next slot (slot n+1) and store the updated PDP, the updated PDP_{QCL source}, in association with one of the next slot (slot n+1) as a reference slot or the QCL class indicated by the regular index. The combining operation, in some aspects, may be (as non-limiting examples) a loop filter/filtering, an IIR filter/filtering, or any other combining operation determined by, or configured for, the UE. The UE may continue to identify a ‘next’ slot and perform the estimation/computation and update the PDP until (and including) reaching a last slot for the DMRS combining (e.g., slot n+m). The UE may perform the joint channel estimation based on the plurality of DMRSs in the plurality of slots (e.g., including at least the first DMRS 915, the second DMRS 925, and the third DMRS 935) using, or based on, the stored updated PDP (e.g., updated based on the plurality of combining operations based on the plurality of DMRS/slots). Based on the joint channel estimation, the UE may then perform the demodulation of the PDSCH 919 of the first slot 910. While the above descriptions of FIGS. 7A, 7B, 8A, 8B, and 9 discuss a joint channel estimation for a demodulation of a single slot (e.g., either the first slot or the second slot), the joint channel estimation, in some aspects, may be for, or associated with, a demodulation of additional slots associated with the joint channel estimation.

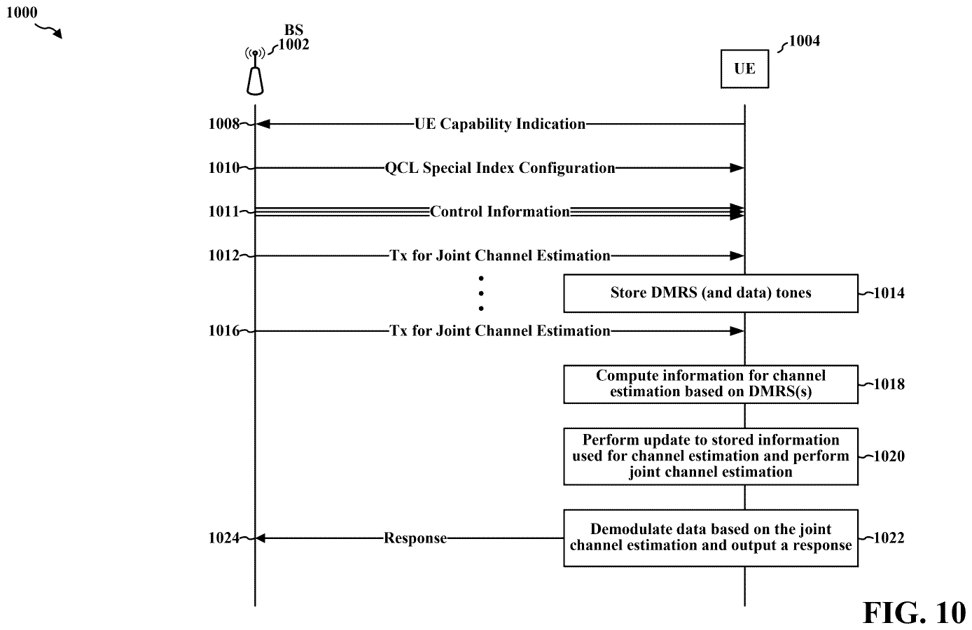

FIG. 10 is a call flow diagram 1000 illustrating a method of wireless communication in accordance with some aspects of the disclosure. The method is illustrated in relation to a base station 1002 (e.g., as an example of a network device or network node that may include one or more components of a disaggregated base station) in communication with a UE 1004 (e.g., as an example of a wireless device). The functions ascribed to the base station 1002, in some aspects, may be performed by one or more components of a network entity, a network node, or a network device (a single network entity/node/device or a disaggregated network entity/node/device as described above in relation to FIG. 1). Similarly, the functions ascribed to the UE 1004, in some aspects, may be performed by one or more components of a wireless device supporting communication with a network entity/node/device. Accordingly, references to “transmitting” in the description below may be understood to refer to a first component of the base station 1002 (or the UE 1004) outputting (or providing) an indication of the content of the transmission to be transmitted by a different component of the base station 1002 (or the UE 1004). Similarly, references to “receiving” in the description below may be understood to refer to a first component of the base station 1002 (or the UE 1004) receiving a transmitted signal and outputting (or providing) the received signal (or information based on the received signal) to a different component of the base station 1002 (or the UE 1004).

The UE 1004, in some aspects, may transmit, and the base station 1002 may receive, a UE capability indication 1008 indicating support for the special index (or special index class) of, or associated with, a type of QCL (e.g., QCL Type E). In some aspects, the UE capability indication 1008 may be based on an ability for the UE to buffer DMRS, or DMRS and data/PDSCH, tones from a first slot (or a plurality of slots) associated with a joint channel estimation (or cross-slot DMRS combining). In some aspects, if the UE capability indication 1008 indicates support for the special index, the base station 1002 may interpret the UE capability indication 1008 as indicating support for the use of the special index and for performing the joint channel estimation (or cross-slot DMRS combining). Accordingly, in some aspects, the UE 1004 may omit a transmission of a separate indication of support for the joint channel estimation (or cross-slot DMRS combining).

Based on the UE capability indication 1008, the base station 1002 may transmit, and the UE 1004 may receive, a QCL special index configuration 1010. The QCL special index configuration 1010, in some aspects, may be an RRC message indicating a maximum number of subsequent slots that may be indicated by a special index (e.g., via a first set of bits or a first field). In some aspects, the QCL special index configuration 1010, may further indicate a mapping between values (or codepoints) that may be included in the first set of bits (or first field) and numbers of subsequent slots associated with the joint channel estimation (or cross-slot DMRS combining). For example, if the UE capability indication 1008 indicates support for storing DMRS (but not data) for up to one slot, the QCL special index configuration 1010 may indicate that a single bit special index (as described in relation to FIGS. 7A and 8A) may be used and the base station 1002 may know that the UE 1004 does not support non-causal joint channel estimation. If the UE capability indication 1008 indicates support for storing DMRS and data for up to one slot, the QCL special index configuration 1010 may indicate that a single bit special index (as described in relation to FIGS. 7A, 7B, 8A, and 8B) may be used and the base station 1002 may know that the UE 1004 supports non-causal joint channel estimation. In some aspects, if the UE capability indication 1008 indicates support for storing DMRS and data for up to M slots, the QCL special index configuration 1010 may indicate that a multi-bit special index (as described in relation to FIG. 9) may be used and the base station 1002 may know that the UE 1004 supports the use of M slots for a non-causal joint channel estimation.

Based on the QCL special index configuration 1010, the base station 1002 may transmit, and the UE 1004 may receive, control information 1011. The control information 1011, in some aspects, may include DCI that schedules, or is associated with, a set of slots. The control information 1011, or the DCI included in the control information 1011, may indicate to, or for, the UE to perform a joint channel estimation (or cross-slot DMRS combining) for the set of slots and to perform an update to information used for channel estimation.

For example, the control information 1011 may include, in association with (or for) at least a first slot and a second slot adjacent to the first slot, a first indication to perform a joint channel estimation for at least one of the first slot or the second slot based on at least a first set of DMRSs associated with the first slot (e.g., a first set of DMRSs including a DMRS for each port used to transmit the set of DMRSs in the first slot) and a second set of DMRSs associated with the second slot (e.g., a second set of DMRSs including a DMRS for each port used to transmit the set of DMRSs in the second slot). In some aspects, the control information 1011 may include, for the first slot, a second indication of a type of QCL of the first set of DMRSs with a first reference set of DMRSs associated with a first reference slot. In some aspects, the type of QCL indicates to the UE to perform an update to information used for the joint channel estimation, and the information is based on the first reference set of DMRSs. The second indication of the type of QCL of the first set of DMRSs, in some aspects, may be based on the first indication to perform the joint channel estimation. In some aspects, the control information 1011 may include, for the second slot, a third indication of the type of QCL of the second set of DMRSs with a second reference set of DMRSs associated with a second reference slot. The type of QCL, in some aspects, indicates to the UE to perform an additional update to the information used for the joint channel estimation based on the second set of DMRSs, and the information is based on the second reference set of DMRSs. In some aspects, the second indication and the third indication use different methods to indicate a reference set of DMRSs based on being associated with the first indication.

While reference to a first slot and a second slot appear in the above discussion of the control information 1011, the terms “first” and “second” may not reflect an ordering of the slots in time. Accordingly, for a pair of adjacent slots including a slot n and a slot n+1, the “first” slot may refer to slot n, while the “second” slot refers to slot n+1, or vice versa. For example, referring to FIGS. 7A and 7B, the “first” slot as used in relation to the control information 1011, would refer to the slot n+1, while the “second” slot as used in relation to the control information 1011, would refer to the slot n. Conversely, referring to FIGS. 8A and 8B, the “first” slot as used in relation to the control information 1011, would refer to the slot n, while the “second” slot as used in relation to the control information 1011, would refer to the slot n+1. In some aspects, the “first” slot may refer to the slot associated with control messaging (e.g., the indication of the QCL type) including (or based on) the special index, while the “second” slot may refer to the slot associated with control messaging (e.g., the indication of the QCL type) including (or based on) the regular index as described in relation to FIGS. 7A, 7B, 8A, 8B, and 9.

For example, as described in relation to FIG. 7A, in some aspects, the second slot precedes the first slot, and the joint channel estimation is associated with a demodulation of data associated with the first slot. The first indication may further indicate to store tones associated with the second set of DMRSs (e.g., tones used in performing the joint channel estimation and/or DMRS combining and demodulation of the data associated with the first slot). As discussed above, the second indication may use a first method of the different methods to indicate a reference set of DMRSs, where the first method to indicate a reference set of DMRSs may include identifying the first reference set of DMRSs using a first set of bits of a first instance of a control message. The third indication, in some aspects, may use a second method of the different methods, where the second method may include identifying the second reference set of DMRSs using a second set of bits of a second instance of the control message, and where the first set of bits is smaller than the second set of bits. The first set of bits, in some aspects, may be a single bit for indicating one of (1) that the first reference set of DMRSs is the second set of DMRSs or (2) that the first reference set of DMRSs is indicated in the second set of bits. In some aspects, the control message is DCI, and the first set of bits precedes the second set of bits. The second set of bits, in some aspects, may be ignored if the first set of bits indicates that the first reference set of DMRSs is the second set of DMRSs.

As described in relation to FIG. 7B, in some aspects, the second slot precedes the first slot, and the joint channel estimation is associated with a demodulation of data associated with the second slot. The first indication may further indicate to store first tones associated with the second set of DMRSs and second tones associated with a physical downlink shared channel (PDSCH) of the second slot (e.g., tones used in performing the joint channel estimation and/or DMRS combining and demodulation of the data associated with the second slot). As discussed above, the second indication may use a first method of the different methods to indicate a reference set of DMRSs, where the first method to indicate a reference set of DMRSs may include identifying the first reference set of DMRSs using a first set of bits of a first instance of a control message. The third indication, in some aspects, may use a second method of the different methods, where the second method may include identifying the second reference set of DMRSs using a second set of bits of a second instance of the control message, and where the first set of bits is smaller than the second set of bits. The first set of bits, in some aspects, may be a single bit for indicating one of (1) that the first reference set of DMRSs is the second set of DMRSs or (2) that the first reference set of DMRSs is indicated in the second set of bits. In some aspects, the control message is DCI, and the first set of bits precedes the second set of bits. The second set of bits, in some aspects, may be ignored if the first set of bits indicates that the first reference set of DMRSs is the second set of DMRSs.

As described in relation to FIG. 8B, the first slot, in some aspects, precedes the second slot and the joint channel estimation is associated with a demodulation of data associated with the first slot. The first indication may further indicate to store first tones associated with the first set of DMRSs and second tones associated with a physical downlink shared channel (PDSCH) of the first slot (e.g., tones used in performing the joint channel estimation and/or DMRS combining and demodulation of the data associated with the second slot). As discussed above, the second indication may use a first method of the different methods to indicate a reference set of DMRSs, where the first method to indicate a reference set of DMRSs may include identifying the first reference set of DMRSs using a first set of bits of a first instance of a control message. The third indication, in some aspects, may use a second method of the different methods, where the second method may include identifying the second reference set of DMRSs using a second set of bits of a second instance of the control message, and where the second set of bits is larger than the first set of bits. The first set of bits, in some aspects, may be a single bit for indicating one of (1) that the first reference set of DMRSs is the second set of DMRSs or (2) that the first reference set of DMRSs is indicated in the second set of bits. In some aspects, the control message is DCI, and the first set of bits precedes the second set of bits. The second set of bits, in some aspects, may be ignored if the first set of bits indicates that the first reference set of DMRSs is the second set of DMRSs.

As described in relation to FIG. 9, in some aspects, the first slot precedes the second slot and the second slot is one of a plurality of slots, where the joint channel estimation is associated with a demodulation of data associated with at least the first slot based on the first set of DMRSs associated with the first slot and a plurality of sets of DMRSs associated with the plurality of slots, where the first indication further indicates to store first tones associated with the first set of DMRSs and second tones associated with a physical downlink shared channel (PDSCH) of the first slot (e.g., tones used in performing the joint channel estimation and/or DMRS combining and demodulation of the data associated with the second slot). As discussed above, the second indication may use a first method of the different methods to indicate a reference set of DMRSs, where the first method to indicate a reference set of DMRSs may include using a first set of bits of a first instance of a control message to identify the plurality of slots. The third indication, in some aspects, may use a second method of the different methods, where the second method may include identifying the second reference set of DMRSs using a second set of bits of a second instance of the control message, and where the second set of bits is larger than the first set of bits. The first set of bits, in some aspects, may be a set of bits for indicating one of (1) a number of subsequent slots and associated sets of DMRSs associated with the performing of the joint channel estimation for the first slot or (2) that the first reference set of DMRSs is indicated in the second set of bits. In some aspects, the control message is DCI, and the first set of bits precedes the second set of bits. The second set of bits, in some aspects, may be ignored if the first set of bits indicates that the first reference set of DMRSs is the second set of DMRSs.

Based on, or in association with, the control information 1011, the base station 1002 may transmit, and the UE 1004 may receive, a plurality of transmissions associated with the joint channel estimation. The plurality of transmissions, in some aspects, includes at least a first transmission 1012 in a first slot. At 1014, the UE may store the DMRS tones received in at least the first slot and, for non-causal joint channel estimation (or non-causal DMRS combining) tones associated with the data, or a PDSCH, received in at least the first slot. In some aspects, additional DMRS tones received in other slots associated with the joint channel estimation may be stored at 1014. The plurality of transmissions, in some aspects, also includes at least a second transmission 1016 in a second slot. In some aspects, the second transmission 1016 in a second slot may be a final, or m^{th}, slot in a set of m additional slots used to perform a joint channel estimation for, and demodulation of, the first transmission 1012 received in the first slot.

At 1018, the UE 1004 may compute at least (1) first information (e.g., first information used in a channel estimation such as a first PDP or first FD correlation) based on the first set of DMRSs and (2) second information (e.g., second information used in a channel estimation such as a second PDP or second FD correlation) based on the second set of DMRSs. In some aspects, additional information may be computed based on the addition sets DMRSs received in the additional slots associated with the joint channel estimation.

At 1020, the UE 1004 may, for a first slot that precedes a second slot, update (1) first stored information based on the first information and (2) the updated first stored information based on the second information. As discussed above, if the second slot precedes the first slot, the UE 1004 may update (1) first stored information based on the second information and (2) the updated first stored information based on the first information. Updating particular stored information, in some aspects, may include performing a combining operation to adjust the particular stored information based on computed information based on a “current” set of DMRSs. As discussed above, the updating, or the combining operation, in some aspects, may be (as non-limiting examples) a loop filter/filtering, an IIR filter/filtering, or any other combining operation determined by, or configured for, the UE. The updated information, in some aspects, may be stored as it is produced, or generated, to be used for a subsequent updating (based on subsequently received QCL'ed DMRS) and or channel estimation.

At 1020, the UE 1004 may further, based on the updated information, perform a joint channel estimation (e.g., the joint channel estimation associated with the first indication received in the control information 1011). Based on the joint channel estimation performed at 1020, the UE may, at 1022, demodulate data for at least one slot associated with the joint channel estimation and output a response associated with the joint channel estimation for the at least one of the first slot or the second slot. For example, the UE, at 1022, may transmit, and the base station 1002 may receive, the response 1024 associated with the joint channel estimation for the at least one of the first slot or the second slot, or store the response associated with the joint channel estimation for the at least one of the first slot or the second slot.

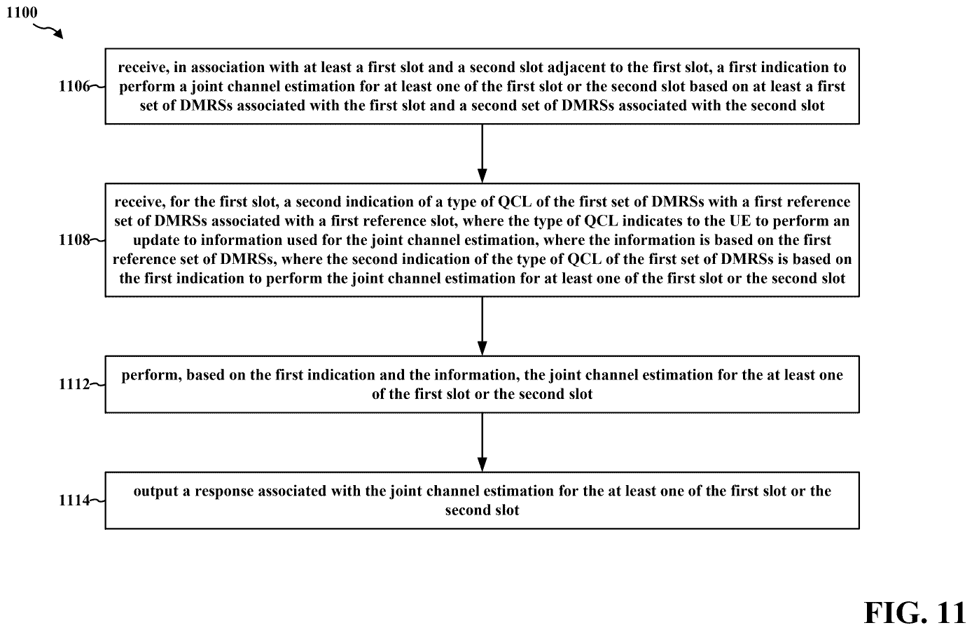

FIG. 11 is a flowchart 1100 of a method of wireless communication. The method may be performed by a wireless device such as a UE (e.g., the UE 104, 1004; the apparatus 1504). In some aspects, the UE may transmit a first capability indication of support for receiving indications of a type of QCL using different methods to indicate a reference set of DMRSs based on being associated with a first indication to perform the joint channel estimation. For example, referring to FIG. 10, the UE 1004 may transmit a UE capability indication 1008 indicating support for the special index (or special index class) of, or associated with, a type of QCL (e.g., QCL Type E). In some aspects, the UE may receive, via an RRC message, a maximum number of subsequent slots that may be indicated via the first set of bits. For example, referring to FIG. 10, the UE 1004 may receive a QCL special index configuration 1010.

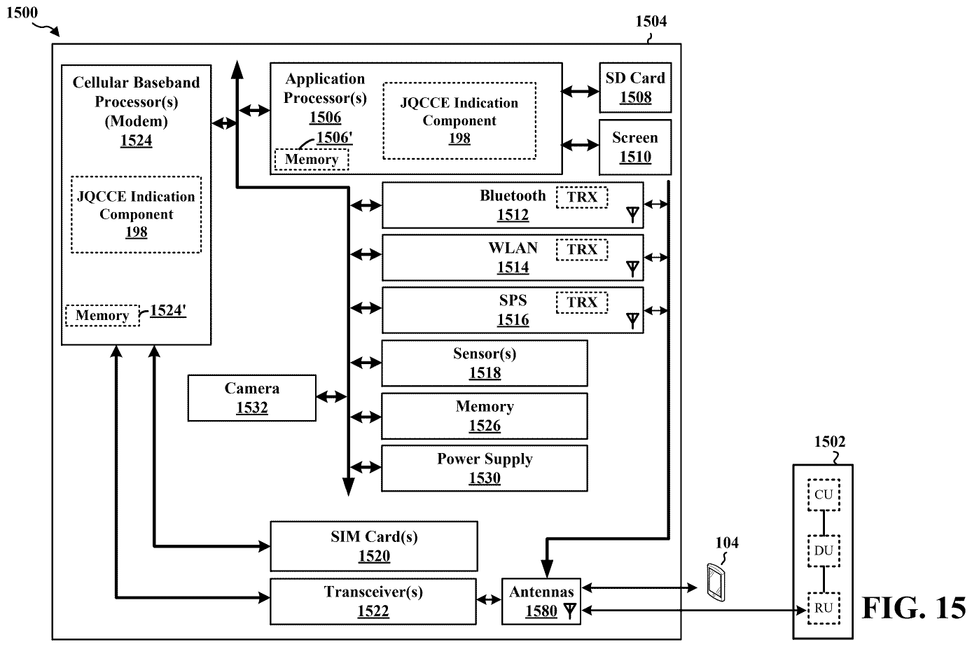

At 1106, the UE may receive, in association with at least a first slot and a second slot adjacent to the first slot, a first indication to perform a joint channel estimation for at least one of the first slot or the second slot based on at least a first set of DMRSs associated with the first slot and a second set of DMRSs associated with the second slot. For example, 1106 may be performed by application processor(s) 1506, cellular baseband processor(s) 1524, transceiver(s) 1522, antenna(s) 1580, and/or JQCCE indication component 198 of FIG. 15. The first indication may further indicate to store tones associated with at least one of the first set of DMRSs or the second set of DMRSs. In some aspects, the first indication may further indicate to store first tones associated with at least one of the first set of DMRSs or the second set of DMRSs and to store second tones associated with a physical downlink shared channel (PDSCH) of at least one of the first slot or the second slot (e.g., tones used in performing the joint channel estimation and/or DMRS combining and demodulation of the data associated with the second slot). For example, referring to FIG. 10, the UE 1004 may receive a control information 1011 that may include DCI that schedules, or is associated with, a set of slots and where the control information 1011, or the DCI included in the control information 1011, indicates to, or for, the UE to perform a joint channel estimation (or cross-slot DMRS combining) for the set of slots.

At 1108, the UE may receive, for the first slot, a second indication of a type of QCL of the first set of DMRSs with a first reference set of DMRSs associated with a first reference slot. The type of QCL, in some aspects, may indicate to the UE to perform an update to information used for the joint channel estimation. In some aspects, the second indication of the type of QCL of the first set of DMRSs may be based on the first indication to perform the joint channel estimation. For example, 1108 may be performed by application processor(s) 1506, cellular baseband processor(s) 1524, transceiver(s) 1522, antenna(s) 1580, and/or JQCCE indication component 198 of FIG. 15. In some aspects, the information may be based on the first reference set of DMRSs. The second indication may use a first method of different methods to indicate a reference set of DMRSs, where the first method to indicate a reference set of DMRSs may include identifying the first reference set of DMRSs using a first set of bits of a first instance of a control message. The first set of bits, in some aspects, may be a single bit for indicating one of (1) that the first reference set of DMRSs is the second set of DMRSs or (2) that the first reference set of DMRSs is indicated in the second set of bits. In some aspects, the first set of bits may be a set of bits for indicating one of (1) a number of subsequent slots and associated sets of DMRSs associated with the performing of the joint channel estimation for the first slot or (2) that the first reference set of DMRSs is indicated in the second set of bits. In some aspects, the control message is DCI, and the first set of bits precedes the second set of bits. The second set of bits, in some aspects, may be ignored if the first set of bits indicates that the first reference set of DMRSs is the second set of DMRSs. For example, referring to FIG. 10, the UE 1004 may receive a control information 1011 that may include DCI that schedules, or is associated with, a set of slots and where the control information 1011, or the DCI included in the control information 1011, indicates to, or for, the UE to perform an update to information used for channel estimation.

In some aspects, the UE may receive, for the second slot, a third indication of the type of QCL of the second set of DMRSs with a second reference set of DMRSs associated with a second reference slot. In some aspects, the type of QCL may indicate to the UE to perform an additional update to the information used for the joint channel estimation based on the second set of DMRSs. The second indication and the third indication, in some aspects, may use different methods to indicate a reference set of DMRSs based on being associated with the first indication. In some aspects, the information may be based on the second reference set of DMRSs. The third indication, in some aspects, may use a second method of the different methods, where the second method may include identifying the second reference set of DMRSs using a second set of bits of a second instance of the control message, and where the first set of bits is smaller than the second set of bits. For example, referring to FIG. 10, the UE 1004 may receive a control information 1011 that may include DCI that schedules, or is associated with, a set of slots and where the control information 1011, or the DCI included in the control information 1011, indicates to, or for, the UE to perform an update to information used for channel estimation.

At 1112, the UE may perform, based on the first indication and the information, the joint channel estimation for the at least one of the first slot or the second slot. For example, 1112 may be performed by application processor(s) 1506, cellular baseband processor(s) 1524, transceiver(s) 1522, antenna(s) 1580, and/or JQCCE indication component 198 of FIG. 15. In some aspects, to perform the joint channel estimation the UE may: (1) compute first information based on the first set of DMRSs, (2) update, based on the first information, first stored information, (3) compute second information based on the second set of DMRSs, (4) update, based on the second information, the updated first stored information to produce updated second information, and (5) store the updated second information for use for a subsequent channel estimation. In some aspects, updating the updated first stored information may include performing a combining operation to adjust the updated first stored information based on the second information. For example, referring to FIG. 10, the UE 1004 may, at 1020, the UE 1004 may, for a first slot that precedes a second slot, update (1) first stored information based on the first information, (2) the updated first stored information based on the second information, and (3) perform a joint channel estimation.

At 1114, the UE may output a response associated with the joint channel estimation for the at least one of the first slot or the second slot. For example, 1114 may be performed by application processor(s) 1506, cellular baseband processor(s) 1524, transceiver(s) 1522, antenna(s) 1580, and/or JQCCE indication component 198 of FIG. 15. In some aspects, to output the response at 1114, the UE may transmit the response associated with the joint channel estimation for the at least one of the first slot or the second slot, or store the response associated with the joint channel estimation for the at least one of the first slot or the second slot. For example, referring to FIG. 10, the UE 1004 may, at 1022, demodulate data for at least one slot associated with the joint channel estimation and output a response associated with the joint channel estimation for the at least one of the first slot or the second slot and may transmit the response 1024 associated with the joint channel estimation for the at least one of the first slot or the second slot, or store the response associated with the joint channel estimation for the at least one of the first slot or the second slot.

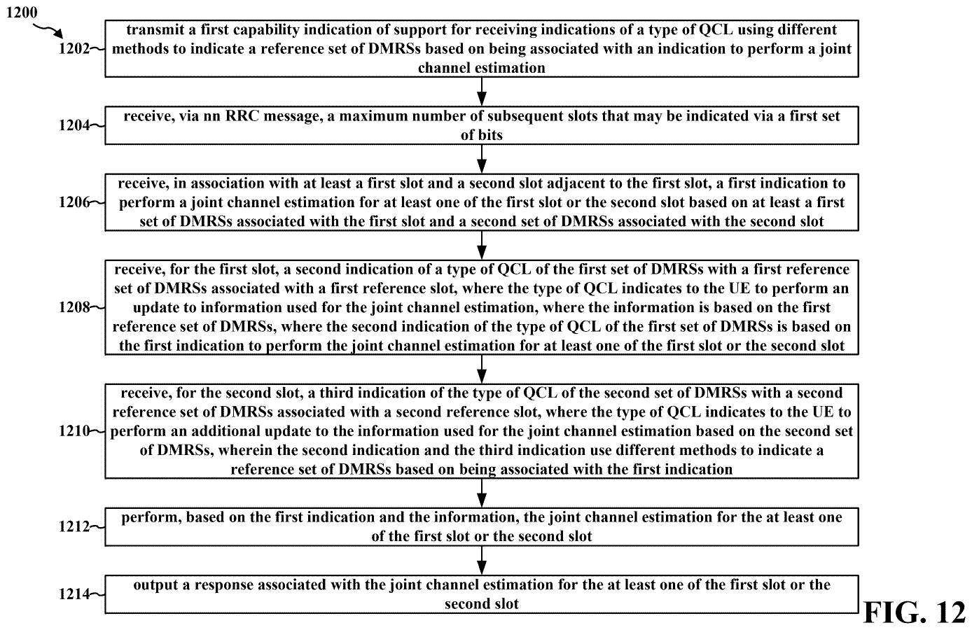

FIG. 12 is a flowchart 1200 of a method of wireless communication. The method may be performed by a wireless device such as a UE (e.g., the UE 104, 1004; the apparatus 1504). At 1202, the UE may transmit a first capability indication of support for receiving indications of a type of QCL using different methods to indicate a reference set of DMRSs based on being associated with a first indication to perform the joint channel estimation. For example, 1202 may be performed by application processor(s) 1506, cellular baseband processor(s) 1524, transceiver(s) 1522, antenna(s) 1580, and/or JQCCE indication component 198 of FIG. 15. For example, referring to FIG. 10, the UE 1004 may transmit a UE capability indication 1008 indicating support for the special index (or special index class) of, or associated with, a type of QCL (e.g., QCL Type E).

At 1204, the UE may receive, via an RRC message, a maximum number of subsequent slots that may be indicated via the first set of bits. For example, 1204 may be performed by application processor(s) 1506, cellular baseband processor(s) 1524, transceiver(s) 1522, antenna(s) 1580, and/or JQCCE indication component 198 of FIG. 15. For example, referring to FIG. 10, the UE 1004 may receive a QCL special index configuration 1010.

At 1206, the UE may receive, in association with at least a first slot and a second slot adjacent to the first slot, a first indication to perform a joint channel estimation for at least one of the first slot or the second slot based on at least a first set of DMRSs associated with the first slot and a second set of DMRSs associated with the second slot. For example, 1206 may be performed by application processor(s) 1506, cellular baseband processor(s) 1524, transceiver(s) 1522, antenna(s) 1580, and/or JQCCE indication component 198 of FIG. 15. The first indication may further indicate to store tones associated with at least one of the first set of DMRSs or the second set of DMRSs. In some aspects, the first indication may further indicate to store first tones associated with at least one of the first set of DMRSs or the second set of DMRSs and to store second tones associated with a physical downlink shared channel (PDSCH) of at least one of the first slot or the second slot (e.g., tones used in performing the joint channel estimation and/or DMRS combining and demodulation of the data associated with the second slot). For example, referring to FIG. 10, the UE 1004 may receive a control information 1011 that may include DCI that schedules, or is associated with, a set of slots and where the control information 1011, or the DCI included in the control information 1011, indicates to, or for, the UE to perform a joint channel estimation (or cross-slot DMRS combining) for the set of slots.

At 1208, the UE may receive, for the first slot, a second indication of a type of QCL of the first set of DMRSs with a first reference set of DMRSs associated with a first reference slot. The type of QCL, in some aspects, may indicate to the UE to perform an update to information used for the joint channel estimation. In some aspects, the second indication of the type of QCL of the first set of DMRSs may be based on the first indication to perform the joint channel estimation. For example, 1208 may be performed by application processor(s) 1506, cellular baseband processor(s) 1524, transceiver(s) 1522, antenna(s) 1580, and/or JQCCE indication component 198 of FIG. 15. In some aspects, the information may be based on the first reference set of DMRSs. The second indication may use a first method of different methods to indicate a reference set of DMRSs, where the first method to indicate a reference set of DMRSs may include identifying the first reference set of DMRSs using a first set of bits of a first instance of a control message. The first set of bits, in some aspects, may be a single bit for indicating one of (1) that the first reference set of DMRSs is the second set of DMRSs or (2) that the first reference set of DMRSs is indicated in the second set of bits. In some aspects, the first set of bits may be a set of bits for indicating one of (1) a number of subsequent slots and associated sets of DMRSs associated with the performing of the joint channel estimation for the first slot or (2) that the first reference set of DMRSs is indicated in the second set of bits. In some aspects, the control message is DCI, and the first set of bits precedes the second set of bits. The second set of bits, in some aspects, may be ignored if the first set of bits indicates that the first reference set of DMRSs is the second set of DMRSs. For example, referring to FIG. 10, the UE 1004 may receive a control information 1011 that may include DCI that schedules, or is associated with, a set of slots and where the control information 1011, or the DCI included in the control information 1011, indicates to, or for, the UE to perform an update to information used for channel estimation.

At 1210, the UE may receive, for the second slot, a third indication of the type of QCL of the second set of DMRSs with a second reference set of DMRSs associated with a second reference slot. In some aspects, the type of QCL may indicate to the UE to perform an additional update to the information used for the joint channel estimation based on the second set of DMRSs. The second indication and the third indication, in some aspects, may use different methods to indicate a reference set of DMRSs based on being associated with the first indication. For example, 1210 may be performed by application processor(s) 1506, cellular baseband processor(s) 1524, transceiver(s) 1522, antenna(s) 1580, and/or JQCCE indication component 198 of FIG. 15. In some aspects, the information may be based on the second reference set of DMRSs. The third indication, in some aspects, may use a second method of the different methods, where the second method may include identifying the second reference set of DMRSs using a second set of bits of a second instance of the control message, and where the first set of bits is smaller than the second set of bits. For example, referring to FIG. 10, the UE 1004 may receive a control information 1011 that may include DCI that schedules, or is associated with, a set of slots and where the control information 1011, or the DCI included in the control information 1011, indicates to, or for, the UE to perform an update to information used for channel estimation.

At 1212, the UE may perform, based on the first indication and the information, the joint channel estimation for the at least one of the first slot or the second slot. For example, 1212 may be performed by application processor(s) 1506, cellular baseband processor(s) 1524, transceiver(s) 1522, antenna(s) 1580, and/or JQCCE indication component 198 of FIG. 15. In some aspects, to perform the joint channel estimation the UE may: (1) compute first information based on the first set of DMRSs, (2) update, based on the first information, first stored information, (3) compute second information based on the second set of DMRSs, (4) update, based on the second information, the updated first stored information to produce updated second information, and (5) store the updated second information for use for a subsequent channel estimation. In some aspects, updating the updated first stored information may include performing a combining operation to adjust the updated first stored information based on the second information. For example, referring to FIG. 10, the UE 1004 may, at 1020, the UE 1004 may, for a first slot that precedes a second slot, update (1) first stored information based on the first information, (2) the updated first stored information based on the second information, and (3) perform a joint channel estimation.

At 1214, the UE may output a response associated with the joint channel estimation for the at least one of the first slot or the second slot. For example, 1214 may be performed by application processor(s) 1506, cellular baseband processor(s) 1524, transceiver(s) 1522, antenna(s) 1580, and/or JQCCE indication component 198 of FIG. 15. In some aspects, to output the response at 1214, the UE may transmit the response associated with the joint channel estimation for the at least one of the first slot or the second slot, or store the response associated with the joint channel estimation for the at least one of the first slot or the second slot. For example, referring to FIG. 10, the UE 1004 may, at 1022, demodulate data for at least one slot associated with the joint channel estimation and output a response associated with the joint channel estimation for the at least one of the first slot or the second slot and may transmit the response 1024 associated with the joint channel estimation for the at least one of the first slot or the second slot, or store the response associated with the joint channel estimation for the at least one of the first slot or the second slot.

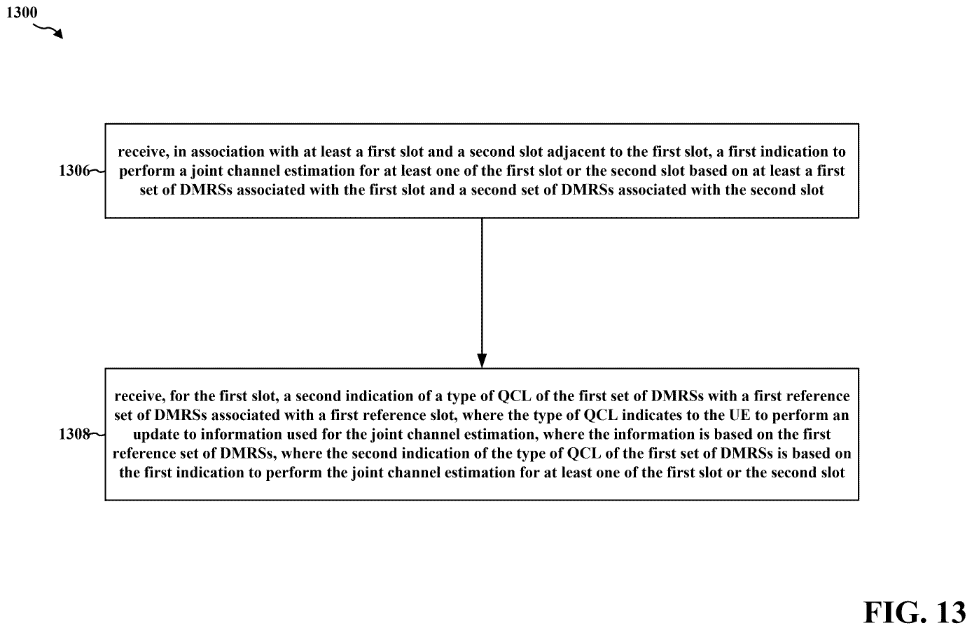

FIG. 13 is a flowchart 1300 of a method of wireless communication. The method may be performed by a network device such as a base station (e.g., the base station 102, 1002; the network entity 1502, 1602). In some aspects, the base station may receive a first capability indication of support for receiving indications of a type of QCL using different methods to indicate a reference set of DMRSs based on being associated with a first indication to perform the joint channel estimation. For example, referring to FIG. 10, the base station 1002 may receive a UE capability indication 1008 indicating support for the special index (or special index class) of, or associated with, a type of QCL (e.g., QCL Type E). In some aspects, the base station may transmit via an RRC message, a maximum number of subsequent slots that may be indicated via the first set of bits. For example, referring to FIG. 10, the base station 1002 may transmit a QCL special index configuration 1010.

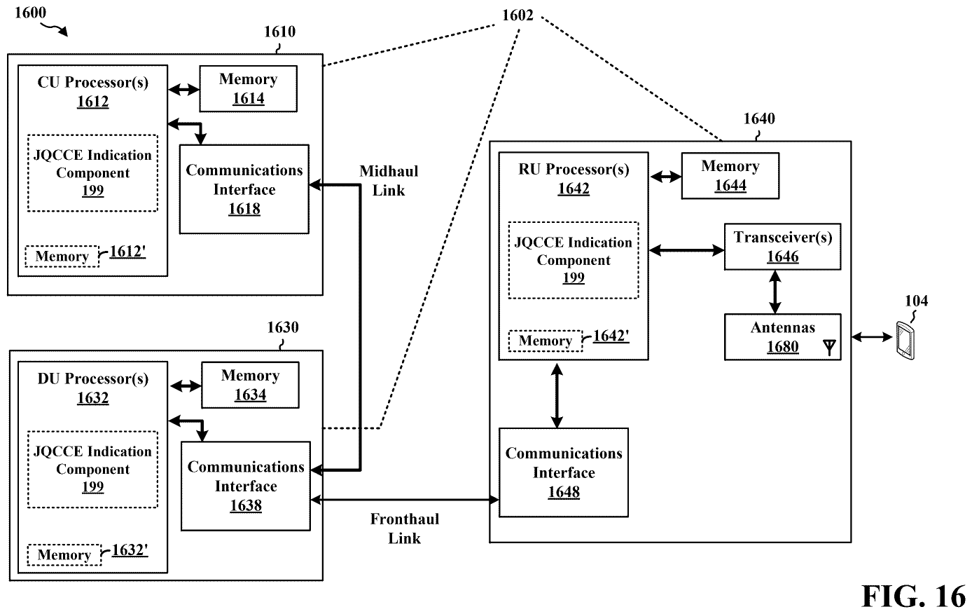

At 1306, the base station may transmit, in association with at least a first slot and a second slot adjacent to the first slot, a first indication to perform a joint channel estimation for at least one of the first slot or the second slot based on at least a first set of DMRSs associated with the first slot and a second set of DMRSs associated with the second slot. For example, 1306 may be performed by CU processor(s) 1612, DU processor(s) 1632, RU processor(s) 1642, transceiver(s) 1646, antenna(s) 1680, and/or JQCCE indication component 199 of FIG. 16. The first indication may further indicate (for the UE) to store tones associated with at least one of the first set of DMRSs or the second set of DMRSs. In some aspects, the first indication may further indicate to store first tones associated with at least one of the first set of DMRSs or the second set of DMRSs and to store second tones associated with a physical downlink shared channel (PDSCH) of at least one of the first slot or the second slot (e.g., tones used in performing the joint channel estimation and/or DMRS combining and demodulation of the data associated with the second slot). For example, referring to FIG. 10, the base station 1002 may transmit a control information 1011 that may include DCI that schedules, or is associated with, a set of slots and where the control information 1011, or the DCI included in the control information 1011, indicates to, or for, the UE to perform a joint channel estimation (or cross-slot DMRS combining) for the set of slots.

At 1308, the base station may transmit, for the first slot, a second indication of a type of QCL of the first set of DMRSs with a first reference set of DMRSs associated with a first reference slot. The type of QCL, in some aspects, may indicate to the UE to perform an update to information used for the joint channel estimation. In some aspects, the second indication of the type of QCL of the first set of DMRSs may be based on the first indication to perform the joint channel estimation. For example, 1308 may be performed by CU processor(s) 1612, DU processor(s) 1632, RU processor(s) 1642, transceiver(s) 1646, antenna(s) 1680, and/or JQCCE indication component 199 of FIG. 16. In some aspects, the information may be based on the first reference set of DMRSs. The second indication may use a first method of different methods to indicate a reference set of DMRSs, where the first method to indicate a reference set of DMRSs may include identifying the first reference set of DMRSs using a first set of bits of a first instance of a control message. The first set of bits, in some aspects, may be a single bit for indicating one of (1) that the first reference set of DMRSs is the second set of DMRSs or (2) that the first reference set of DMRSs is indicated in the second set of bits. In some aspects, the first set of bits may be a set of bits for indicating one of (1) a number of subsequent slots and associated sets of DMRSs associated with the performing of the joint channel estimation for the first slot or (2) that the first reference set of DMRSs is indicated in the second set of bits. In some aspects, the control message is DCI, and the first set of bits precedes the second set of bits. The second set of bits, in some aspects, may be ignored if the first set of bits indicates that the first reference set of DMRSs is the second set of DMRSs. For example, referring to FIG. 10, the base station 1002 may transmit control information 1011 that may include DCI that schedules, or is associated with, a set of slots and where the control information 1011, or the DCI included in the control information 1011, indicates to, or for, the UE to perform an update to information used for channel estimation.

In some aspects, the base station may transmit, for the second slot, a third indication of the type of QCL of the second set of DMRSs with a second reference set of DMRSs associated with a second reference slot. In some aspects, the type of QCL may indicate to the UE to perform an additional update to the information used for the joint channel estimation based on the second set of DMRSs. The second indication and the third indication, in some aspects, may use different methods to indicate a reference set of DMRSs based on being associated with the first indication. In some aspects, the information may be based on the second reference set of DMRSs. The third indication, in some aspects, may use a second method of the different methods, where the second method may include identifying the second reference set of DMRSs using a second set of bits of a second instance of the control message, and where the first set of bits is smaller than the second set of bits. For example, referring to FIG. 10, the base station 1002 may transmit control information 1011 that may include DCI that schedules, or is associated with, a set of slots and where the control information 1011, or the DCI included in the control information 1011, indicates to, or for, the UE to perform an update to information used for channel estimation.

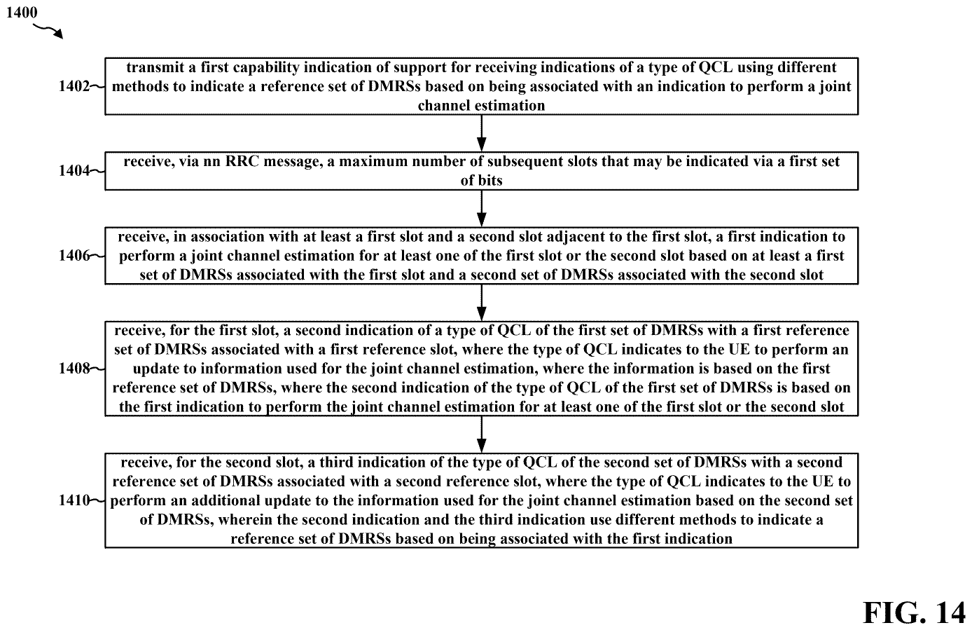

FIG. 14 is a flowchart 1400 of a method of wireless communication. The method may be performed by a network device such as a base station (e.g., the base station 102, 1002; the network entity 1502, 1602). At 1402, the base station may receive a first capability indication of support for receiving indications of a type of QCL using different methods to indicate a reference set of DMRSs based on being associated with a first indication to perform the joint channel estimation. For example, 1402 may be performed by CU processor(s) 1612, DU processor(s) 1632, RU processor(s) 1642, transceiver(s) 1646, antenna(s) 1680, and/or JQCCE indication component 199 of FIG. 16. For example, referring to FIG. 10, the base station 1002 may receive a UE capability indication 1008 indicating support for the special index (or special index class) of, or associated with, a type of QCL (e.g., QCL Type E).

At 1404, the base station may transmit via an RRC message, a maximum number of subsequent slots that may be indicated via the first set of bits. For example, 1404 may be performed by CU processor(s) 1612, DU processor(s) 1632, RU processor(s) 1642, transceiver(s) 1646, antenna(s) 1680, and/or JQCCE indication component 199 of FIG. 16. For example, referring to FIG. 10, the base station 1002 may transmit a QCL special index configuration 1010.

At 1406, the base station may transmit, in association with at least a first slot and a second slot adjacent to the first slot, a first indication to perform a joint channel estimation for at least one of the first slot or the second slot based on at least a first set of DMRSs associated with the first slot and a second set of DMRSs associated with the second slot. For example, 1406 may be performed by CU processor(s) 1612, DU processor(s) 1632, RU processor(s) 1642, transceiver(s) 1646, antenna(s) 1680, and/or JQCCE indication component 199 of FIG. 16. The first indication may further indicate (for the UE) to store tones associated with at least one of the first set of DMRSs or the second set of DMRSs. In some aspects, the first indication may further indicate to store first tones associated with at least one of the first set of DMRSs or the second set of DMRSs and to store second tones associated with a physical downlink shared channel (PDSCH) of at least one of the first slot or the second slot (e.g., tones used in performing the joint channel estimation and/or DMRS combining and demodulation of the data associated with the second slot). For example, referring to FIG. 10, the base station 1002 may transmit a control information 1011 that may include DCI that schedules, or is associated with, a set of slots and where the control information 1011, or the DCI included in the control information 1011, indicates to, or for, the UE to perform a joint channel estimation (or cross-slot DMRS combining) for the set of slots.

At 1408, the base station may transmit, for the first slot, a second indication of a type of QCL of the first set of DMRSs with a first reference set of DMRSs associated with a first reference slot. The type of QCL, in some aspects, may indicate to the UE to perform an update to information used for the joint channel estimation. In some aspects, the second indication of the type of QCL of the first set of DMRSs may be based on the first indication to perform the joint channel estimation. For example, 1408 may be performed by CU processor(s) 1612, DU processor(s) 1632, RU processor(s) 1642, transceiver(s) 1646, antenna(s) 1680, and/or JQCCE indication component 199 of FIG. 16. In some aspects, the information may be based on the first reference set of DMRSs. The second indication may use a first method of different methods to indicate a reference set of DMRSs, where the first method to indicate a reference set of DMRSs may include identifying the first reference set of DMRSs using a first set of bits of a first instance of a control message. The first set of bits, in some aspects, may be a single bit for indicating one of (1) that the first reference set of DMRSs is the second set of DMRSs or (2) that the first reference set of DMRSs is indicated in the second set of bits. In some aspects, the first set of bits may be a set of bits for indicating one of (1) a number of subsequent slots and associated sets of DMRSs associated with the performing of the joint channel estimation for the first slot or (2) that the first reference set of DMRSs is indicated in the second set of bits. In some aspects, the control message is DCI, and the first set of bits precedes the second set of bits. The second set of bits, in some aspects, may be ignored if the first set of bits indicates that the first reference set of DMRSs is the second set of DMRSs. For example, referring to FIG. 10, the base station 1002 may transmit control information 1011 that may include DCI that schedules, or is associated with, a set of slots and where the control information 1011, or the DCI included in the control information 1011, indicates to, or for, the UE to perform an update to information used for channel estimation.

At 1410, the base station may transmit, for the second slot, a third indication of the type of QCL of the second set of DMRSs with a second reference set of DMRSs associated with a second reference slot. In some aspects, the type of QCL may indicate to the UE to perform an additional update to the information used for the joint channel estimation based on the second set of DMRSs. The second indication and the third indication, in some aspects, may use different methods to indicate a reference set of DMRSs based on being associated with the first indication. For example, 1410 may be performed by CU processor(s) 1612, DU processor(s) 1632, RU processor(s) 1642, transceiver(s) 1646, antenna(s) 1680, and/or JQCCE indication component 199 of FIG. 16. In some aspects, the information may be based on the second reference set of DMRSs. The third indication, in some aspects, may use a second method of the different methods, where the second method may include identifying the second reference set of DMRSs using a second set of bits of a second instance of the control message, and where the first set of bits is smaller than the second set of bits. For example, referring to FIG. 10, the base station 1002 may transmit control information 1011 that may include DCI that schedules, or is associated with, a set of slots and where the control information 1011, or the DCI included in the control information 1011, indicates to, or for, the UE to perform an update to information used for channel estimation.

FIG. 15 is a diagram 1500 illustrating an example of a hardware implementation for an apparatus 1504. The apparatus 1504 may be a UE, a component of a UE, or may implement UE functionality. In some aspects, the apparatus 1504 may include at least one cellular baseband processor 1524 (also referred to as a modem) coupled to one or more transceivers 1522 (e.g., cellular RF transceiver). The cellular baseband processor(s) 1524 may include at least one on-chip memory 1524′. In some aspects, the apparatus 1504 may further include one or more subscriber identity modules (SIM) cards 1520 and at least one application processor 1506 coupled to a secure digital (SD) card 1508 and a screen 1510. The application processor(s) 1506 may include on-chip memory 1506′. In some aspects, the apparatus 1504 may further include a Bluetooth module 1512, a WLAN module 1514, an SPS module 1516 (e.g., GNSS module), one or more sensor modules 1518 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1526, a power supply 1530, and/or a camera 1532. The Bluetooth module 1512, the WLAN module 1514, and the SPS module 1516 may include an on-chip transceiver (TRX) (or in some cases, just a receiver (RX)). The Bluetooth module 1512, the WLAN module 1514, and the SPS module 1516 may include their own dedicated antennas and/or utilize one or more antennas 1580 for communication. The cellular baseband processor(s) 1524 communicates through the transceiver(s) 1522 via the one or more antennas 1580 with the UE 104 and/or with an RU associated with a network entity 1502. The cellular baseband processor(s) 1524 and the application processor(s) 1506 may each include a computer-readable medium/memory 1524′, 1506′, respectively. The additional memory modules 1526 may also be considered a computer-readable medium/memory. Each computer-readable medium/memory 1524′, 1506′, 1526 may be non-transitory. The cellular baseband processor(s) 1524 and the application processor(s) 1506 are each responsible for general processing, including the execution of software stored on the computer-readable medium/memory. The software, when executed by the cellular baseband processor(s) 1524/application processor(s) 1506, causes the cellular baseband processor(s) 1524/application processor(s) 1506 to perform the various functions described supra. The cellular baseband processor(s) 1524 and the application processor(s) 1506 are configured to perform the various functions described supra based at least in part of the information stored in the memory. That is, the cellular baseband processor(s) 1524 and the application processor(s) 1506 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1524/application processor(s) 1506 when executing software. The cellular baseband processor(s) 1524/application processor(s) 1506 may be a component of the UE 350 and may include the at least one memory 360 and/or at least one of the TX processor 368, the RX processor 356, and the controller/processor 359. In one configuration, the apparatus 1504 may be at least one processor chip (modem and/or application) and include just the cellular baseband processor(s) 1524 and/or the application processor(s) 1506, and in another configuration, the apparatus 1504 may be the entire UE (e.g., see UE 350 of FIG. 3) and include the additional modules of the apparatus 1504.

As discussed supra, the JQCCE indication component 198 may be configured to receive, in association with at least a first slot and a second slot adjacent to the first slot, a first indication to perform a joint channel estimation for at least one of the first slot or the second slot based on at least a first set of DMRSs associated with the first slot and a second set of DMRSs associated with the second slot, receive, for the first slot, a second indication of a type of QCL of the first set of DMRSs with a first reference set of DMRSs associated with a first reference slot, where the type of QCL indicates to the UE to perform an update to information used for the joint channel estimation, where the information is based on the first reference set of DMRSs, where the second indication of the type of QCL of the first set of DMRSs is based on the first indication to perform the joint channel estimation, perform, based on the first indication and the information, the joint channel estimation for the at least one of the first slot or the second slot, and output a response associated with the joint channel estimation for the at least one of the first slot or the second slot. The JQCCE indication component 198 may be within the cellular baseband processor(s) 1524, the application processor(s) 1506, or both the cellular baseband processor(s) 1524 and the application processor(s) 1506. The JQCCE indication component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1504 may include a variety of components configured for various functions. In one configuration, the apparatus 1504, and in particular the cellular baseband processor(s) 1524 and/or the application processor(s) 1506, may include means for receiving, in association with at least a first slot and a second slot adjacent to the first slot, a first indication to perform a joint channel estimation for at least one of the first slot or the second slot based on at least a first set of DMRSs associated with the first slot and a second set of DMRSs associated with the second slot. The apparatus 1504, and in particular the cellular baseband processor(s) 1524 and/or the application processor(s) 1506, may include means for receiving, for the first slot, a second indication of a type of QCL of the first set of DMRSs with a first reference set of DMRSs associated with a first reference slot, where the type of QCL indicates to the UE to perform an update to information used for the joint channel estimation, where the information is based on the first reference set of DMRSs, where the second indication of the type of QCL of the first set of DMRSs is based on the first indication to perform the joint channel estimation. The apparatus 1504, and in particular the cellular baseband processor(s) 1524 and/or the application processor(s) 1506, may include means for performing, based on the first indication and the information, the joint channel estimation for the at least one of the first slot or the second slot. The apparatus 1504, and in particular the cellular baseband processor(s) 1524 and/or the application processor(s) 1506, may include means for outputting a response associated with the joint channel estimation for the at least one of the first slot or the second slot. The apparatus 1504, and in particular the cellular baseband processor(s) 1524 and/or the application processor(s) 1506, may include means for receiving, for the second slot, a third indication of the type of QCL of the second set of DMRSs with a second reference set of DMRSs associated with a second reference slot, where the type of QCL indicates to the UE to perform an additional update to the information used for the joint channel estimation based on the second set of DMRSs, where the information is based on the second reference set of DMRSs, where the second indication and the third indication use different methods to indicate a reference set of DMRSs based on being associated with the first indication. The apparatus 1504, and in particular the cellular baseband processor(s) 1524 and/or the application processor(s) 1506, may include means for computing first information based on the first set of DMRSs. The apparatus 1504, and in particular the cellular baseband processor(s) 1524 and/or the application processor(s) 1506, may include means for updating, based on the first information, first stored information. The apparatus 1504, and in particular the cellular baseband processor(s) 1524 and/or the application processor(s) 1506, may include means for computing second information based on the second set of DMRSs. The apparatus 1504, and in particular the cellular baseband processor(s) 1524 and/or the application processor(s) 1506, may include means for updating, based on the second information, the updated first stored information to produce updated second information. The apparatus 1504, and in particular the cellular baseband processor(s) 1524 and/or the application processor(s) 1506, may include means for storing the updated second information for use for a subsequent channel estimation. The apparatus 1504, and in particular the cellular baseband processor(s) 1524 and/or the application processor(s) 1506, may include means for performing a combining operation to adjust the updated first stored information based on the second information. The apparatus 1504, and in particular the cellular baseband processor(s) 1524 and/or the application processor(s) 1506, may include means for receiving, via a radio resource control (RRC) message, a maximum number of subsequent slots that may be indicated via the first set of bits. The apparatus 1504, and in particular the cellular baseband processor(s) 1524 and/or the application processor(s) 1506, may include means for transmitting a first capability indication of support for receiving indications of the type of QCL using different methods to indicate the reference set of DMRSs based on being associated with the first indication to perform the joint channel estimation. The apparatus 1504, and in particular the cellular baseband processor(s) 1524 and/or the application processor(s) 1506, may include means for transmitting the response associated with the joint channel estimation for the at least one of the first slot or the second slot. The apparatus 1504, and in particular the cellular baseband processor(s) 1524 and/or the application processor(s) 1506, may include means for storing the response associated with the joint channel estimation for the at least one of the first slot or the second slot. The apparatus 1504 may further include means for performing any of the aspects described in connection with the flowcharts in FIG. 11 or 12, and/or performed by the UE in the communication flow of FIG. 10. The means may be the JQCCE indication component 198 of the apparatus 1504 configured to perform the functions recited by the means. As described supra, the apparatus 1504 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 16 is a diagram 1600 illustrating an example of a hardware implementation for a network entity 1602. The network entity 1602 may be a BS, a component of a BS, or may implement BS functionality. The network entity 1602 may include at least one of a CU 1610, a DU 1630, or an RU 1640. For example, depending on the layer functionality handled by the JQCCE indication component 199, the network entity 1602 may include the CU 1610; both the CU 1610 and the DU 1630; each of the CU 1610, the DU 1630, and the RU 1640; the DU 1630; both the DU 1630 and the RU 1640; or the RU 1640. The CU 1610 may include at least one CU processor 1612. The CU processor(s) 1612 may include on-chip memory 1612′. In some aspects, the CU 1610 may further include additional memory modules 1614 and a communications interface 1618. The CU 1610 communicates with the DU 1630 through a midhaul link, such as an F1 interface. The DU 1630 may include at least one DU processor 1632. The DU processor(s) 1632 may include on-chip memory 1632′. In some aspects, the DU 1630 may further include additional memory modules 1634 and a communications interface 1638. The DU 1630 communicates with the RU 1640 through a fronthaul link. The RU 1640 may include at least one RU processor 1642. The RU processor(s) 1642 may include on-chip memory 1642′. In some aspects, the RU 1640 may further include additional memory modules 1644, one or more transceivers 1646, one or more antennas 1680, and a communications interface 1648. The RU 1640 communicates with the UE 104. The on-chip memory 1612′, 1632′, 1642′ and the additional memory modules 1614, 1634, 1644 may each be considered a computer-readable medium/memory. Each computer-readable medium/memory may be non-transitory. Each of the processors 1612, 1632, 1642 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the JQCCE indication component 199 may be configured to transmit, in association with at least a first slot and a second slot adjacent to the first slot, a first indication for a UE to perform a joint channel estimation for at least one of the first slot or the second slot based on at least a first set of DMRSs associated with the first slot and a second set of DMRSs associated with the second slot, and transmit, for the first slot, a second indication of a type of QCL of the first set of DMRSs with a first reference set of DMRSs associated with a first reference slot, where the type of QCL indicates to the UE to perform an update to information used for the joint channel estimation, where the information is based on the first reference set of DMRSs, where the second indication of the type of QCL of the first set of DMRSs is based on the first indication to perform the joint channel estimation for at least one of the first slot or the second slot. The JQCCE indication component 199 may be within one or more processors of one or more of the CU 1610, DU 1630, and the RU 1640. The JQCCE indication component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1602 may include a variety of components configured for various functions. In one configuration, the network entity 1602 may include means for transmitting, in association with at least a first slot and a second slot adjacent to the first slot, a first indication for a UE to perform a joint channel estimation for at least one of the first slot or the second slot based on at least a first set of DMRSs associated with the first slot and a second set of DMRSs associated with the second slot. The network entity 1602, in some aspects, may include means for transmitting, for the first slot, a second indication of a type of QCL of the first set of DMRSs with a first reference set of DMRSs associated with a first reference slot, where the type of QCL indicates to the UE to perform an update to information used for the joint channel estimation, where the information is based on the first reference set of DMRSs, where the second indication of the type of QCL of the first set of DMRSs is based on the first indication to perform the joint channel estimation for at least one of the first slot or the second slot. The network entity 1602, in some aspects, may include means for transmitting, for the second slot, a third indication of the type of QCL of the second set of DMRSs with a second reference set of DMRSs associated with a second reference slot, where the type of QCL indicates to the UE to perform an additional update to the information used for the joint channel estimation based on the second set of DMRSs, where the information is based on the second reference set of DMRSs, where the second indication and the third indication use different methods to indicate a reference set of DMRSs based on being associated with the first indication. The network entity 1602, in some aspects, may include means for transmitting, via a radio resource control (RRC) message, a maximum number of subsequent slots that may be indicated via the first set of bits. The network entity 1602, in some aspects, may include means for receiving a first capability indication of support for receiving indications of the type of QCL using the different methods to indicate the reference set of DMRSs based on being associated with the first indication to perform the joint channel estimation. The network entity 1602 may further include means for performing any of the aspects described in connection with the flowcharts in FIGS. 13 and 14, and/or performed by the base station in the communication flow of FIG. 10. The means may be the JQCCE indication component 199 of the network entity 1602 configured to perform the functions recited by the means. As described supra, the network entity 1602 may include the TX processor 316, the RX processor 370, and the controller/processor 375. As such, in one configuration, the means may be the TX processor 316, the RX processor 370, and/or the controller/processor 375 configured to perform the functions recited by the means.

Various aspects relate generally to a method for joint indication of QCL PDP and cross-slot channel estimation. Some aspects more specifically relate to, utilizing causal and non-causal DMRS combining across transmission time intervals (TTIs) with special index classes (e.g., special codepoints or codepoint indexes) for a type of QCL signaling (e.g., QCL Type E signaling), allowing for dynamic indication by the base station of QCL information and filtering coefficients. In some examples, a UE may be configured to receive, in association with at least a first slot and a second slot adjacent to the first slot, a first indication to perform a joint channel estimation for at least one of the first slot or the second slot based on at least a first set of DMRSs associated with the first slot and a second set of DMRSs associated with the second slot, receive, for the first slot, a second indication of a type of QCL of the first set of DMRSs with a first reference set of DMRSs associated with a first reference slot, where the type of QCL indicates to the UE to perform an update to information used for the joint channel estimation, where the information is based on the first reference set of DMRSs, where the second indication of the type of QCL of the first set of DMRSs is based on the first indication to perform the joint channel estimation, perform, based on the first indication and the information, the joint channel estimation for the at least one of the first slot or the second slot, and output a response associated with the joint channel estimation for the at least one of the first slot or the second slot. In some examples, a network device such as a base station may be configured to transmit, in association with at least a first slot and a second slot adjacent to the first slot, a first indication for a UE to perform a joint channel estimation for at least one of the first slot or the second slot based on at least a first set of DMRSs associated with the first slot and a second set of DMRSs associated with the second slot, and transmit, for the first slot, a second indication of a type of QCL of the first set of DMRSs with a first reference set of DMRSs associated with a first reference slot, where the type of QCL indicates to the UE to perform an update to information used for the joint channel estimation, where the information is based on the first reference set of DMRSs, where the second indication of the type of QCL of the first set of DMRSs is based on the first indication to perform the joint channel estimation for at least one of the first slot or the second slot.

Particular aspects of the subject matter described in this disclosure can be implemented to realize one or more of the following potential advantages. In some examples, by using a joint indication of QCL PDP and cross-slot channel estimation, the described techniques can be used to reduce signaling overhead associated with separate indications of the QCL PDP and cross-slot channel estimation.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S S F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE), comprising: receiving, in association with at least a first slot and a second slot adjacent to the first slot, a first indication to perform a joint channel estimation for at least one of the first slot or the second slot based on at least a first set of demodulation reference signals (DMRSs) associated with the first slot and a second set of DMRSs associated with the second slot; receiving, for the first slot, a second indication of a type of quasi-co-location (QCL) of the first set of DMRSs with a first reference set of DMRSs associated with a first reference slot, wherein the type of QCL indicates to the UE to perform an update to information used for the joint channel estimation, wherein the information is based on the first reference set of DMRSs, wherein the second indication of the type of QCL of the first set of DMRSs is based on the first indication to perform the joint channel estimation; performing, based on the first indication and the information, the joint channel estimation for the at least one of the first slot or the second slot; and outputting a response associated with the joint channel estimation for the at least one of the first slot or the second slot.

Aspect 2 is the method of aspect 1, further comprising: receiving, for the second slot, a third indication of the type of QCL of the second set of DMRSs with a second reference set of DMRSs associated with a second reference slot, wherein the type of QCL indicates to the UE to perform an additional update to the information used for the joint channel estimation based on the second set of DMRSs, wherein the information is based on the second reference set of DMRSs, wherein the second indication and the third indication use different methods to indicate a reference set of DMRSs based on being associated with the first indication.

Aspect 3 is the method of aspect 2, wherein the information comprises one of a power delay profile or a frequency domain correlation, the method further comprising: computing first information based on the first set of DMRSs; updating, based on the first information, first stored information; computing second information based on the second set of DMRSs; updating, based on the second information, the updated first stored information to produce updated second information; and storing the updated second information for use for a subsequent channel estimation.

Aspect 4 is the method of aspect 3, wherein updating the updated first stored information comprises performing a combining operation to adjust the updated first stored information based on the second information.

Aspect 5 is the method of aspect 2, wherein the second slot precedes the first slot, wherein the joint channel estimation is associated with a demodulation of data associated with the first slot, wherein the first indication further indicates to store tones associated with the second set of DMRSs, wherein the second indication uses a first method of the different methods, the first method comprising identifying the first reference set of DMRSs using a first set of bits of a first instance of a control message, wherein the third indication uses a second method of the different methods, the second method comprising identifying the second reference set of DMRSs using a second set of bits of a second instance of the control message, and wherein the first set of bits is smaller than the second set of bits.

Aspect 6 is the method of aspect 5, wherein the first set of bits comprises a single bit for indicating one of that the first reference set of DMRSs is the second set of DMRSs or that the first reference set of DMRSs is indicated in the second set of bits.

Aspect 7 is the method of any of aspects 5 and 6, wherein the control message is downlink control information (DCI) and wherein the first set of bits precedes the second set of bits, and wherein the second set of bits is ignored if the first set of bits indicates that the first reference set of DMRSs is the second set of DMRSs.

Aspect 8 is the method of aspect 2, wherein the second slot precedes the first slot, wherein the joint channel estimation is associated with a demodulation of data associated with the second slot, wherein the first indication further indicates to store first tones associated with the second set of DMRSs and second tones associated with a physical downlink shared channel (PDSCH) of the second slot, wherein the second indication uses a first method of the different methods, the first method comprising identifying the first reference set of DMRSs using a first set of bits of a first instance of a control message, wherein the third indication uses a second method of the different methods, the second method comprising identifying the second reference set of DMRSs using a second set of bits of a second instance of the control message, and wherein the first set of bits is smaller than the second set of bits.

Aspect 9 is the method of aspect of 8, wherein the first set of bits comprises a single bit for indicating one of that the first reference set of DMRSs is the second set of DMRSs or that the first reference set of DMRSs is indicated in the second set of bits.

Aspect 10 is the method of any of aspects 8 and 9, wherein the control message is downlink control information (DCI) and wherein the first set of bits precedes the second set of bits, and wherein the second set of bits is ignored if the first set of bits indicates that the first reference set of DMRSs is the second set of DMRSs.

Aspect 11 is the method of aspect 2, wherein the first slot precedes the second slot, wherein the joint channel estimation is associated with a demodulation of data associated with the first slot, wherein the first indication further indicates to store first tones associated with the first set of DMRSs and second tones associated with a physical downlink shared channel (PDSCH) of the first slot, wherein the second indication uses a first method of the different methods, the first method comprising identifying the first reference set of DMRSs using a first set of bits of a first instance of a control message, wherein the third indication uses a second method of the different methods, the second method comprising identifying the second reference set of DMRSs using a second set of bits of a second instance of the control message, and wherein the second set of bits is larger than the first set of bits.

Aspect 12 is the method of aspect 11, wherein the first set of bits comprises a single bit for indicating one of that the first reference set of DMRSs is the second set of DMRSs or that the first reference set of DMRSs is indicated in the second set of bits.

Aspect 13 is the method of aspect 2, wherein the first slot precedes the second slot, wherein the second slot is one of a plurality of slots, wherein the joint channel estimation is associated with a demodulation of data associated with the first slot based on the first set of DMRSs associated with the first slot and a plurality of sets of DMRSs associated with the plurality of slots, wherein the first indication further indicates to first store tones associated with the first set of DMRSs and second tones associated with a physical downlink shared channel (PDSCH) of the first slot, wherein the second indication uses a first method of the different methods, the first method comprising using a first set of bits of a first instance of a control message to identify the plurality of slots, wherein the third indication uses a second method of the different methods, the second method comprising identifying the second reference set of DMRSs using a second set of bits of a second instance of the control message, and wherein the second set of bits is larger than the first set of bits.

Aspect 14 is the method of aspect 13, wherein the first set of bits comprises a set of bits for indicating one of a number of subsequent slots and associated sets of DMRSs associated with the performing of the joint channel estimation for the first slot or that the first reference set of DMRSs is indicated in the second set of bits.

Aspect 15 is the method of aspect 14, further comprising: receiving, via a radio resource control (RRC) message, a maximum number of subsequent slots that may be indicated via the first set of bits.

Aspect 16 is the method of any of aspects 1 to 15, further comprising: transmitting a first capability indication of support for receiving indications of the type of QCL using different methods to indicate the reference set of DMRSs based on being associated with the first indication to perform the joint channel estimation.

Aspect 17 is the method of any of aspects 1 to 16, wherein outputting the response associated with the joint channel estimation for the at least one of the first slot or the second slot comprises at least one of: transmitting the response associated with the joint channel estimation for the at least one of the first slot or the second slot; or storing the response associated with the joint channel estimation for the at least one of the first slot or the second slot.

Aspect 18 is a method of wireless communication at a network device, comprising: transmitting, in association with at least a first slot and a second slot adjacent to the first slot, a first indication for a user equipment (UE) to perform a joint channel estimation for at least one of the first slot or the second slot based on at least a first set of demodulation reference signals (DMRSs) associated with the first slot and a second set of DMRSs associated with the second slot; and transmitting, for the first slot, a second indication of a type of quasi-co-location (QCL) of the first set of DMRSs with a first reference set of DMRSs associated with a first reference slot, wherein the type of QCL indicates to the UE to perform an update to information used for the joint channel estimation, wherein the information is based on the first reference set of DMRSs, wherein the second indication of the type of QCL of the first set of DMRSs is based on the first indication to perform the joint channel estimation for at least one of the first slot or the second slot.

Aspect 19 is the method of aspect 18, further comprising: transmitting, for the second slot, a third indication of the type of QCL of the second set of DMRSs with a second reference set of DMRSs associated with a second reference slot, wherein the type of QCL indicates to the UE to perform an additional update to the information used for the joint channel estimation based on the second set of DMRSs, wherein the information is based on the second reference set of DMRSs, wherein the second indication and the third indication use different methods to indicate a reference set of DMRSs based on being associated with the first indication.

Aspect 20 is the method of aspect 19, wherein the type of QCL indicates for the UE to perform the update to the information by performing a combining operation to adjust stored information based on the first set of DMRSs.

Aspect 21 is the method of aspect 20, wherein the second slot precedes the first slot, wherein the joint channel estimation is associated with a demodulation of data associated with the first slot, wherein the first indication further indicates to store tones associated with the second set of DMRSs, wherein the second indication uses a first method of the different methods, the first method comprising identifying the first reference set of DMRSs using a first set of bits of a first instance of a control message, wherein the third indication uses a second method of the different methods, the second method comprising identifying the second reference set of DMRSs using a second set of bits of a second instance of the control message, and wherein the first set of bits is smaller than the second set of bits.

Aspect 22 is the method of aspect 21, wherein the first set of bits comprises a single bit for indicating one of that the first reference set of DMRSs is the second set of DMRSs or that the first reference set of DMRSs is indicated in the second set of bits.

Aspect 23 is the method of any of aspects 21 and 22, wherein the control message is downlink control information (DCI) and wherein the first set of bits precedes the second set of bits, and wherein the second set of bits is ignored if the first set of bits indicates that the first reference set of DMRSs is the second set of DMRSs.

Aspect 24 is the method of aspect 20, wherein the second slot precedes the first slot, wherein the joint channel estimation is associated with a demodulation of data associated with the second slot, wherein the first indication further indicates to store first tones associated with the second set of DMRSs and second tones associated with a physical downlink shared channel (PDSCH) of the second slot, wherein the second indication uses a first method of the different methods, the first method comprising identifying the first reference set of DMRSs using a first set of bits of a first instance of a control message, wherein the third indication uses a second method of the different methods, the second method comprising identifying the second reference set of DMRSs using a second set of bits of a second instance of the control message, and wherein the first set of bits is smaller than the second set of bits.

Aspect 25 is the method of aspect 24, wherein the first set of bits comprises a single bit for indicating one of that the first reference set of DMRSs is the second set of DMRSs or that the first reference set of DMRSs is indicated in the second set of bits.

Aspect 26 is the method of any of aspects 24 and 25, wherein the control message is downlink control information (DCI) and wherein the first set of bits precedes the second set of bits, and wherein the second set of bits is ignored if the first set of bits indicates that the first reference set of DMRSs is the second set of DMRSs.

Aspect 27 is the method of aspect 20, wherein the first slot precedes the second slot, wherein the joint channel estimation is associated with a demodulation of data associated with the first slot, wherein the first indication further indicates to store first tones associated with the first set of DMRSs and second tones associated with a physical downlink shared channel (PDSCH) of the first slot, wherein the second indication uses a first method of the different methods, the first method comprising identifying the first reference set of DMRSs using a first set of bits of a first instance of a control message, wherein the third indication uses a second method of the different methods, the second method comprising identifying the second reference set of DMRSs using a second set of bits of a second instance of the control message, and wherein the second set of bits is larger than the first set of bits.

Aspect 28 is the method of aspect 27, wherein the first set of bits comprises a single bit for indicating one of that the first reference set of DMRSs is the second set of DMRSs or that the first reference set of DMRSs is indicated in the second set of bits.

Aspect 29 is the method of aspect of 20, wherein the first slot precedes the second slot, wherein the second slot is one of a plurality of slots, wherein the joint channel estimation is associated with a demodulation of data associated with the first slot based on the first set of DMRSs associated with the first slot and a plurality of DMRSs associated with the plurality of slots, wherein the first indication further indicates to store first tones associated with the first set of DMRSs and second tones associated with a physical downlink shared channel (PDSCH) of the first slot, wherein the second indication uses a first method of the different methods, the first method comprising using a first set of bits of a first instance of a control message to identify the plurality of slots, wherein the third indication uses a second method of the different methods, the second method comprising identifying the second reference set of DMRSs using a second set of bits of a second instance of the control message, and wherein the second set of bits is larger than the first set of bits.

Aspect 30 is the method of aspect 29, wherein the first set of bits comprises a set of bits for indicating one of a number of subsequent slots and associated sets of DMRSs associated with the performance of the joint channel estimation for the first slot or that the first reference set of DMRSs is indicated in the second set of bits.

Aspect 31 is the method of any of aspects 29 and 30, further comprising: transmitting, via a radio resource control (RRC) message, a maximum number of subsequent slots that may be indicated via the first set of bits.

Aspect 32 is the method of any of aspects 20 to 31, further comprising: receiving a first capability indication of support for receiving indications of the type of QCL using the different methods to indicate the reference set of DMRSs based on being associated with the first indication to perform the joint channel estimation.

Aspect 33 is an apparatus for wireless communication at a UE, comprising: at least one memory; and at least one processor coupled to the at least one memory, the at least one processor is configured to perform the method of any of aspects 1 to 17.

Aspect 34 is an apparatus for wireless communication at a UE, comprising means for performing each step in the method of any of aspects 1 to 17.

Aspect 35 is the apparatus of any of aspects 33 to 34, further comprising a transceiver configured to receive or to transmit in association with the method of any of aspects 1 to 17.

Aspect 36 is a computer-readable medium (e.g., a non-transitory computer-readable medium) storing computer executable code at a UE, the code when executed by at least one processor causes the at least one processor to perform the method of any of aspects 1 to 17.

Aspect 37 is an apparatus for wireless communication at a network device, comprising: at least one memory; and at least one processor coupled to the at least one memory, the at least one processor is configured to perform the method of any of aspects 18 to 32.

Aspect 38 is an apparatus for wireless communication at a network device, comprising means for performing each step in the method of any of aspects 18 to 32.

Aspect 39 is the apparatus of any of aspects 37 to 38, further comprising a transceiver configured to receive or to transmit in association with the method of any of aspects 18 to 32.

Aspect 40 is a computer-readable medium (e.g., a non-transitory computer-readable medium) storing computer executable code at a network device, the code when executed by at least one processor causes the at least one processor to perform the method of any of aspects 18 to 32.

What is claimed is:

1. An apparatus for wireless communication at a user equipment (UE), comprising:
at least one memory; and
at least one processor coupled to the at least one memory and, based at least in part on information stored in the at least one memory, the at least one processor is configured to:
receive, in association with at least a first slot and a second slot adjacent to the first slot, a first indication to perform a joint channel estimation for at least one of the first slot or the second slot based on at least a first set of demodulation reference signals (DMRSs) associated with the first slot and a second set of DMRSs associated with the second slot;
receive, for the first slot, a second indication of a type of quasi-co-location (QCL) of the first set of DMRSs with a first reference set of DMRSs associated with a first reference slot, wherein the type of QCL indicates to the UE to perform an update to information used for the joint channel estimation, wherein the information is based on the first reference set of DMRSs, wherein the second indication of the type of QCL of the first set of DMRSs is based on the first indication to perform the joint channel estimation;
perform, based on the first indication and the information, the joint channel estimation for the at least one of the first slot or the second slot; and
output a response associated with the joint channel estimation for the at least one of the first slot or the second slot.

2. The apparatus of claim 1, wherein the at least one processor is further configured to:
receive, for the second slot, a third indication of the type of QCL of the second set of DMRSs with a second reference set of DMRSs associated with a second reference slot, wherein the type of QCL indicates to the UE to perform an additional update to the information used for the joint channel estimation based on the second set of DMRSs, wherein the information is based on the second reference set of DMRSs, wherein the second indication and the third indication use different methods to indicate a reference set of DMRSs based on being associated with the first indication.

3. The apparatus of claim 2, wherein the information comprises one of a power delay profile or a frequency domain correlation, wherein the at least one processor is further configured to:
compute first information based on the first set of DMRSs;
update, based on the first information, first stored information;
compute second information based on the second set of DMRSs;
update, based on the second information, the updated first stored information to produce updated second information; and
store the updated second information for use for a subsequent channel estimation.

4. The apparatus of claim 3, wherein to update the updated first stored information, the at least one processor is configured to perform a combining operation to adjust the updated first stored information based on the second information.

5. The apparatus of claim 2, wherein the second slot precedes the first slot, wherein the joint channel estimation is associated with a demodulation of data associated with the first slot, wherein the first indication further indicates to store tones associated with the second set of DMRSs, wherein the second indication uses a first method of the different methods, the first method comprising identifying the first reference set of DMRSs using a first set of bits of a first instance of a control message, wherein the third indication uses a second method of the different methods, the second method comprising identifying the second reference set of DMRSs using a second set of bits of a second instance of the control message, and wherein the first set of bits is smaller than the second set of bits.

6. The apparatus of claim 5, wherein the control message is downlink control information (DCI) and wherein the first set of bits precedes the second set of bits, and wherein the at least one processor is further configured to ignore the second set of bits if the first set of bits indicates that the first reference set of DMRSs is the second set of DMRSs.

7. The apparatus of claim 2, wherein the second slot precedes the first slot, wherein the joint channel estimation is associated with a demodulation of data associated with the second slot, wherein the first indication further indicates to store first tones associated with the second set of DMRSs and second tones associated with a physical downlink shared channel (PDSCH) of the second slot, wherein the second indication uses a first method of the different methods, the first method comprising identifying the first reference set of DMRSs using a first set of bits of a first instance of a control message, wherein the third indication uses a second method of the different methods, the second method comprising identifying the second reference set of DMRSs using a second set of bits of a second instance of the control message, and wherein the first set of bits is smaller than the second set of bits.

8. The apparatus of claim 2, wherein the first slot precedes the second slot, wherein the joint channel estimation is associated with a demodulation of data associated with the first slot, wherein the first indication further indicates to store first tones associated with the first set of DMRSs and second tones associated with a physical downlink shared channel (PDSCH) of the first slot, wherein the second indication uses a first method of the different methods, the first method comprising identifying the first reference set of DMRSs using a first set of bits of a first instance of a control message, wherein the third indication uses a second method of the different methods, the second method comprising identifying the second reference set of DMRSs using a second set of bits of a second instance of the control message, and wherein the second set of bits is larger than the first set of bits.

9. The apparatus of claim 2, wherein the first slot precedes the second slot, wherein the second slot is one of a plurality of slots, wherein the joint channel estimation is associated with a demodulation of data associated with the first slot based on the first set of DMRSs associated with the first slot and a plurality of sets of DMRSs associated with the plurality of slots, wherein the first indication further indicates to store first tones associated with the first set of DMRSs and second tones associated with a physical downlink shared channel (PDSCH) of the first slot, wherein the second indication uses a first method of the different methods, the first method comprising using a first set of bits of a first instance of a control message to identify the plurality of slots, wherein the third indication uses a second method of the different methods, the second method comprising identifying the second reference set of DMRSs using a second set of bits of a second instance of the control message, and wherein the second set of bits is larger than the first set of bits.

10. The apparatus of claim 9, wherein the first set of bits comprises a set of bits for indicating one of subsequent slots and associated sets of DMRSs associated with the performing of the joint channel estimation for the first slot or that the first reference set of DMRSs is indicated in the second set of bits.

11. The apparatus of claim 10, wherein the at least one processor is further configured to:
receive, via a radio resource control (RRC) message, a maximum number of subsequent slots that may be indicated via the first set of bits.

12. The apparatus of claim 1, further comprising a transceiver coupled to the at least one processor, wherein the at least one processor is further configured to:
transmit, via the transceiver, a first capability indication of support for receiving indications of the type of QCL using different methods to indicate the reference set of DMRSs based on being associated with the first indication to perform the joint channel estimation.

13. A method of wireless communication at a user equipment (UE), comprising:
receiving, in association with at least a first slot and a second slot adjacent to the first slot, a first indication to perform a joint channel estimation for at least one of the first slot or the second slot based on at least a first set of demodulation reference signals (DMRSs) associated with the first slot and a second set of DMRSs associated with the second slot;
receiving, for the first slot, a second indication of a type of quasi-co-location (QCL) of the first set of DMRSs with a first reference set of DMRSs associated with a first reference slot, wherein the type of QCL indicates to the UE to perform an update to information used for the joint channel estimation, wherein the information is based on the first reference set of DMRSs, wherein the second indication of the type of QCL of the first set of DMRSs is based on the first indication to perform the joint channel estimation;
performing, based on the first indication and the information, the joint channel estimation for the at least one of the first slot or the second slot; and
outputting a response associated with the joint channel estimation for the at least one of the first slot or the second slot.

14. The method of claim 13, further comprising:
receiving, for the second slot, a third indication of the type of QCL of the second set of DMRSs with a second reference set of DMRSs associated with a second reference slot, wherein the type of QCL indicates to the UE to perform an additional update to the information used for the joint channel estimation based on the second set of DMRSs, wherein the information is based on the second reference set of DMRSs, wherein the second indication and the third indication use different methods to indicate a reference set of DMRSs based on being associated with the first indication.

15. The method of claim 14, wherein the information comprises one of a power delay profile or a frequency domain correlation, the method further comprising:
computing first information based on the first set of DMRSs;
updating, based on the first information, first stored information;
computing second information based on the second set of DMRSs;
updating, based on the second information, the updated first stored information to produce updated second information; and
storing the updated second information for use for a subsequent channel estimation.

16. The method of claim 15, wherein updating the updated first stored information comprises performing a combining operation to adjust the updated first stored information based on the second information.

17. The method of claim 14, wherein the second slot precedes the first slot, wherein the joint channel estimation is associated with a demodulation of data associated with the first slot, wherein the first indication further indicates to store tones associated with the second set of DMRSs, wherein the second indication uses a first method of the different methods, the first method comprising identifying the first reference set of DMRSs using a first set of bits of a first instance of a control message, wherein the third indication uses a second method of the different methods, the second method comprising identifying the second reference set of DMRSs using a second set of bits of a second instance of the control message, and wherein the first set of bits is smaller than the second set of bits.

18. The method of claim 17, wherein the control message is downlink control information (DCI) and wherein the first set of bits precedes the second set of bits, and wherein the second set of bits is ignored if the first set of bits indicates that the first reference set of DMRSs is the second set of DMRSs.

19. The method of claim 13, further comprising:
transmitting a first capability indication of support for receiving indications of the type of QCL using different methods to indicate the reference set of DMRSs based on being associated with the first indication to perform the joint channel estimation.

20. An apparatus for wireless communication at a network device, comprising:
at least one memory; and
at least one processor coupled to the at least one memory and, based at least in part on information stored in the at least one memory, the at least one processor is configured to:
transmit, in association with at least a first slot and a second slot adjacent to the first slot, a first indication for a user equipment (UE) to perform a joint channel estimation for at least one of the first slot or the second slot based on at least a first set of demodulation reference signals (DMRSs) associated with the first slot and a second set of DMRSs associated with the second slot; and
transmit, for the first slot, a second indication of a type of quasi-co-location (QCL) of the first set of DMRSs with a first reference set of DMRSs associated with a first reference slot, wherein the type of QCL indicates to the UE to perform an update to information used for the joint channel estimation, wherein the information is based on the first reference set of DMRSs, wherein the second indication of the type of QCL of the first set of DMRSs is based on the first indication to perform the joint channel estimation for at least one of the first slot or the second slot.
